(19) United States
(12) Patent Application Publication
(10) Pub. No.: US 2024/0254148 A1
(43) Pub. Date: Aug. 1, 2024

(54) METHODS OF MAKING METAL-ORGANIC FRAMEWORKS WITH PRE-LIGANDS

(71) Applicant: ExxonMobil Technology and Engineering Company, Annandale, NJ (US)

(72) Inventors: Joseph M. Falkowski, Hampton, NJ (US); Mary S. Abdulkarim, Palisades Park, NJ (US); Trong D. Pham, Flemington, NJ (US); Julie J. Seo, Clinton, NJ (US)

(21) Appl. No.: 18/413,176

(22) Filed: Jan. 16, 2024

Related U.S. Application Data
(60) Provisional application No. 63/480,666, filed on Jan. 19, 2023.

(51) Int. Cl. C07F 7/00; B01J 20/22

(52) U.S. Cl. CPC C07F 7/00; B01J 20/226; C07B 2200/13

(57) ABSTRACT

Provided herein are methods of making metal-organic frameworks comprising combining a first pre-ligand and at least one of a second pre-ligand or a first ligand with a metal source comprising a metal component to provide a plurality of reactants where at least 50 wt % of the reaction mixture is the plurality of reactants after solvent has been added to the plurality of reactants. Also provided herein are methods of making metal-organic frameworks comprising combining a pre-ligand with a metal source selected from metal acetates, metal hydroxyacetates, metal carbonates, metal hydroxycarbonates, and mixtures thereof.

### CROSS REFERENCE TO RELATED APPLICATIONS

The present application claims the priority benefit of U.S. Provisional Patent Application No. 63/480,666 filed on Jan. 19, 2023 titled “METHODS OF MAKING METAL-ORGANIC FRAMEWORKS WITH PRE-LIGANDS”, by which Application No. 63/480,666 is incorporated herein by reference in its entirety.

### FIELD

The present disclosure is directed to methods of making metal-organic frameworks with a first pre-ligand and at least one of a second pre-ligand or first ligand. The present disclosure is also directed to methods of making metal-organic frameworks by reacting a pre-ligand with a metal source selected from metal acetates, metal hydroxyacetates, metal carbonates, metal hydroxycarbonates, and mixtures thereof.

### BACKGROUND

Metal-organic frameworks (“MOFs”) are constructed with a three-dimensional assembly of metal ions/metal cluster and organic ligands.

Metal-organic frameworks comprise organic ligands (referred to sometimes as “linkers”) that bridge metal nodes (referred to as “secondary building units” or “SBUs”) through coordination bonds and can self-assemble to form a coordination network. In contrast to other porous materials, MOFs further offer unique structural diversity including uniform pore structures, atomic-level structural uniformity, tunable porosity, extensive varieties, and flexibility in network topology, geometry, dimension, and chemical functionality allowing for manipulation of framework topology, porosity, and functionality. Tunable topologies, cither through isoreticular expansion or functionalization of the organic ligand/metal node, make metal-organic frameworks customizable for various different applications ranging from catalytic transformations to adsorption and separations to biomedical applications, including photo catalysis, catalysis, separation and purification, such as gas adsorption and gas separations, gas/energy storage, heating/cooling, batteries, sensing and environmental remediation. High surface areas and high concentration of isolated metal ions enhance gas storage capacity and mass transportation.

The scale up for the commercial manufacture of metal-organic frameworks is challenged by the need for toxic and costly organic solvents. In certain cases, water and/or other low-cost, benign solvents can be utilized. However, in many instances, the low solubility of organic ligands requires the use of polar aprotic solvents, such as dimethylformamide (“DMF”). Under these conditions, it is desirable to operate with a reaction mixture having the highest concentration of reactants as possible. This is challenging as certain reactions suffer from poor crystallinity of materials produced and/or loss of phase specificity at high concentrations which ultimately limits the application of the materials.

To date, several approaches have attempted to circumvent this limitation, including methods that limit or avoid the use of such toxic and costly organic solvents, in particular methods that avoid the use of DMF. For example, alternative synthetic conditions have included use of water dilution to mitigate the need for dimethylformamide (“DMF”) in the solvent mixture. Other alternative methods include the use of solubilizing groups such as amino or carboxy groups which can be appended to the terephthalate ligand to impart improved solubility. However, this approach increases the cost of starting materials and can serve to degrade materials properties such as lower crystallinity or lower intrinsic adsorption selectivity. Other methods utilize solvents which are less toxic, use bio-derived lactones as a metal-organic framework precursor and/or use depolymerized polyethylene terephthalate (“PET”) as a ligand source. See, Zhou, L. et al. (2019) “Direct Synthesis of Robust hep UiO-66 (Zr) MOF Using Poly(ethylene terephthalate) Waste as Ligand Source,” Micro. Meso. Mater., v. 290, pg. 109674; Dyosiba, X. et al. (2019) “Feasibility of Varied Polyethylene Terephthalate Wastes as a Linker Source in Metal-Organic Framework UiO-66 (Zr) Synthesis,” Ind. Eng. Chem. Res., v. 58, pp. 17010-17016. PET comprises two main components, namely benzene dicarboxylic acid (BDC), a building block in the synthesis of BDC-based metal-organic frameworks, and ethylene glycol. PET can be extracted using various techniques. BDC derived from PET wastes can then be applied in the green synthesis of functional metal-organic frameworks. Id. However, even a lot of these alternatives still suffer from the need for a solvent recovery system on any commercial production line.

Stability of a metal-organic framework (“MOF”) can be attributed to strong interactions between ions of low polarizability such as carboxylates and trivalent metals. Stable metal-organic frameworks were initially relegated to phthalate-based MOFs derived from trivalent cations, namely Al³⁺, Fe³⁺, and Cr³⁺. Subsequently, other multivalent cations such as Zr⁴⁺, Hf⁴⁺, or Ti⁴⁺ were utilized to provide additional robust frameworks.

A metal-organic framework UiO-66 was first discovered by reacting zirconium salts with linear dicarboxylic acids. Cavka, J. H. et al. (2008) “A New Zirconium Inorganic Building Brick Forming Metal Organic Frameworks with Exceptional Stability,” J. Am. Chem. Soc., v. 130(42), pp. 13850-13851.

EMM-71, a metal-organic framework comprising a plurality of tetravalent cations and terephthalate linkers crystallized in a primitive cubic lattice, characterized by a high number of missing-cluster/node defects (corresponding to highly defected or even fully defective UiO-66 as measured by relative intensity which reflects the degree of defects), has been described in WO/2023/278246 filed Jun. 23, 2022, incorporated herein by reference. Said EMM-71 was initially produced by reacting a first metal precursor, in particular that can generate a tetravalent metal cation in solution, a second metal precursor, in particular that can generate a divalent metal cation in solution, and a polytopic organic carboxylic acid, such as one that can generate terephthalate linkers, in a solvent, such as dimethylformamide (DMF). Despite these advances, there remains a need for new methods of making MOFs.

### SUMMARY

Provided herein, in a first aspect, are methods of making a metal-organic framework comprising the steps of combining a first pre-ligand and at least one of a second pre-ligand or a first ligand with a metal source comprising a metal component to provide a plurality of reactants; adding a solvent to the plurality of reactants to form a reaction mixture; heating the reaction mixture; and cooling the reaction mixture to produce an insoluble portion and a soluble portion, wherein the insoluble portion comprises a plurality of metal-organic frameworks. Each metal-organic framework comprises at least one ligand and the metal component.

In the first aspect of the present disclosure, at least 50 wt. % of the reaction mixture is the plurality of reactants. When the reaction mixture is heated, the first pre-ligand is converted to a second ligand in the reaction mixture. Also, the second pre-ligand, if present in the reaction mixture, is converted to a third ligand. The second ligand and the at least one of the first ligand or third ligand react with the metal component.

In the first aspect of the present disclosure, the first pre-ligand is selected from the group consisting of dimethylfumarate, dimethyl terephthalate, terephthalonitrile (1,4-dicyanobenzene), terephthalamide (1,4-benzenedicarboxamide), N¹,N⁴-dimethylterepthalamide, dimethyl 2-aminoterephthalate, dimethyl 2-nitroterephthalate, dimethyl 2-chloroterephthalate, dimethyl 2-bromoterephthalate, trimethyl 1,2,4-benzene tricarboxylate, trimethyl 1,3,5-benzene tricarboxylate, tetramethyl 1,2,4,5-benzene tetracarboxylate, polyethylene terephthalate, and mixtures thereof.

In the first aspect of the present disclosure, the second pre-ligand is selected from the group consisting of C2-C10 linear or branched alkyl esters of fumarate, terephthalate, 2-aminoterephthalate, 2-nitroterephthalate, 2-chloroterephthalate, 2-bromoterephthalate, 1,2,4-benzene tricarboxylate, 1,3,5-benzene tricarboxylate, 1,2,4,5-benzene tetracarboxylate, and mixtures thereof.

In the first aspect of the present disclosure, the first ligand is selected from the group consisting of fumaric acid, terephthalic acid, 2-aminoterephthalic acid, 2-nitroterephthalic acid, 2-chloroterephthalic acid, 2-bromoterephthalic acid, 1,2,4-benzene tricarboxylic acid, 1,3,5-benzene tricarboxylic acid, 1,2,4,5-benzene tetracarboxylic acid, and mixtures thereof.

Also provided herein, in a second aspect, are methods method of making a metal-organic framework comprising the steps of combining a pre-ligand with a metal source comprising a metal component to provide a plurality of reactants; adding a solvent to the plurality of reactants to form a reaction mixture; heating the reaction mixture wherein the pre-ligand is converted to a ligand in the reaction mixture and the ligand reacts with the metal component; and cooling the reaction mixture to produce a soluble portion and an insoluble portion and a soluble portion, wherein the insoluble portion comprises a plurality of the metal-organic frameworks. Each metal-organic framework comprises the ligand and the metal component.

In the second aspect of the present disclosure, the metal source is selected from the group consisting of metal hydroxides, metal acetates, metal hydroxyacetates, metal carbonates, metal hydroxycarbonates, and mixtures thereof and between 15 wt. % and 50 wt. % of the reaction mixture is the plurality of reactants. In addition, the reaction mixture does not comprise dimethylformamide.

These and other features and attributes of the disclosed methods of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1A and FIG. 1B are scanning electron microscope (“SEM”) micrographs taken at respectively 5 and 10 μm scale of the EMM-71 material of comparative example 1.

FIG. 2A and FIG. 2B are SEM micrographs taken at 5 and 10 μm scale of the EMM-71 material of comparative example 2.

FIG. 3 shows powder X-ray diffraction patterns of the EMM-71 materials of examples 1A to 1F.

FIG. 4A, FIG. 4B, FIG. 4C, FIG. 4D, FIG. 4E, FIG. 4F, FIG. 4G, FIG. 4H, FIG. 4I, FIG. 4J, FIG. 4K, and FIG. 4L are SEM micrographs of the EMM-71 materials of examples 1A to 1F, at 30 and 10 μm scale.

FIG. 5 is a plot of the mean (▪) and median (♦) particles size as measured by laser sizing of the EMM-71 materials of examples 1A (0 mol % DET), 1B (10 mol % DET), 1D (40 mol % DET) and 1F (80 mol % DET). The line in FIG. 5 represents the pore volume of the EMM-71 materials of examples 1A, 1B, 1D and 1F, as measured by nitrogen adsorption at 77K at 0.8 P/P₀.

FIG. 6 is a plot of the full width at half maximum (FWHM) of the (111) (●) and (110) (▪) peaks of the EMM-71 materials of examples 1A (0 mol % DET), 1B (10 mol % DET), 1D (40 mol % DET) and 1F (80 mol % DET).

FIG. 7 shows the powder X-ray diffraction patterns of the EMM-71 materials of examples 2A to 2G.

FIG. 8A, FIG. 8B, FIG. 8C, FIG. 8D, FIG. 8E, and FIG. 8F are SEM micrographs of the EMM-71 materials of example 2B, 2C and 2D at respectively 30 and 10 μm scale. More particularly, FIG. 8A-8B correspond to example 2B (10 mol % DEHT), FIG. 8C-8D correspond to example 2C (20 mol % DEHT), and FIG. 8E-8F correspond to example 2D (40 mol % DEHT).

FIG. 9 is a plot of the FWHM of the (111) (●) and (110) (▪) peaks of the EMM-71 materials of examples 2A, to 2F. The line in FIG. 9 represents the pore volume of the EMM-71 materials of examples 2A to 2D, as measured by nitrogen adsorption at 77K at 0.8 P/P₀ as described in Example 2.

FIG. 10A and FIG. 10B show the powder X-ray diffraction patterns of the EMM-71 materials of examples 3A to 3G.

FIG. 11 is a plot of pore volume of the EMM-71 materials of examples 3A to 3G.

FIG. 12 shows the powder X-ray diffraction patterns of the EMM-71 materials of examples 4A to 4I (upper curve corresponding to example 4A and bottom curve corresponding to example 4I).

FIG. 13 shows powder X-ray diffraction patterns of the EMM-71 material of example 5.

### DETAILED DESCRIPTION

Before the present compounds, components, compositions, and/or methods are disclosed and described, it is to be understood that unless otherwise indicated this disclosure is not limited to specific compounds, components, compositions, reactants, reaction conditions, ligands, catalyst structures, MOF structures, or the like, as such may vary, unless otherwise specified. It is also to be understood that the terminology used herein is for the purpose of describing particular embodiments and is not intended to be limiting.

All numerical values within the detailed description and the claims herein are modified by “about” or “approximately” the indicated value, taking into account experimental error and variations.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

For the purposes of this disclosure, the following definitions will apply:

As used herein, the terms “a” and “the” as used herein are understood to encompass the plural as well as the singular.

As used herein, a “metal-organic framework” can be a mixed-metal organic framework or a metal-organic framework system or a mixed-metal mixed-organic framework system as described in PCT Patent Publication No. WO2020/219907.

As used herein, a ligand (also referred to as a “linker”) is a compound that bridges two or more metals (metal nodes) to form a coordination network in a metal-organic framework. The protonation status of the ligand can change during the course of the reaction and different protonation states of a ligand are collectively described as a single ligand.

As used herein, a pre-ligand or a precursor is a compound that participates in a chemical reaction to produce another compound and/or a compound from which a ligand is formed.

It is understood that, in any compound described herein having one or more chiral centers, if an absolute stereochemistry is not expressly indicated, then each center may independently be of R-configuration or S-configuration or a mixture thereof. Thus, the compounds provided herein may be enantiomerically pure or be stereoisomeric mixtures.

In addition, it is understood that, in any compound described herein having one or more double bond(s) generating geometrical isomers that can be defined as E or Z, each double bond may independently be E or Z or a mixture thereof. Likewise, it is understood that, in any compound described, all tautomeric forms are also intended to be included.

In addition, the compounds provided herein may also contain unnatural proportions of atomic isotopes at one or more of the atoms that constitute such compounds. For example, the compounds may be radiolabeled with radioactive isotopes, such as for example tritium (³H), iodine-125 (¹²⁵I) or carbon-14 (¹⁴C). All isotopic variations of the subject compounds, whether radioactive or not, are intended to be encompassed within the scope of present disclosure.

In addition, the compounds provided herein can contain differential protonation states depending on solution pH. All conjugate acids and bases of the compounds are intended to be encompassed within the scope of the present disclosure.

The current methodologies provide further alternatives for the synthesis of metal-organic frameworks comprising metal ions of multivalent cations, in particular of tetravalent cations, such as zirconium, titanium, cerium and hafnium.

### Traditional Synthesis

Traditionally, metal-organic frameworks are prepared by reactions of pre-synthesized or commercially available linkers with metal ions. An alternative approach, referred to as “in situ linker synthesis,” specified organic linkers (linkers) can be generated in the reaction media in situ from the starting materials.

In synthesizing the metal-organic framework, organic molecules are not only structure-directing agents but as reactants to be incorporated as part of the framework structure. With this in mind, elevated reaction temperatures are generally employed in conventional synthesis. Solvothermal reaction conditions, structure-directing agents, mineralizers as well as microwave-assisted synthesis or steam-assisted conversions have also been recently introduced.

As referred to herein, the traditional synthesis is typically applied reactions carried out by conventional electric heating without any parallel reactions. In the traditional synthesis, reaction temperature is a primary parameter of a synthesis of the metal-organic framework and two temperature ranges, solvothermal and non-solvothermal, are normally distinguished, which dictate the kind of reaction setups to be used. Solvothermal reactions generally take place in closed vessels under autogenous pressure about the boiling point of the solvent used. Non-solvothermal reactions take place below, or at the boiling point under ambient pressure, simplifying synthetic requirements. Non-solvothermal reactions can be further classified as room-temperature or elevated temperatures.

Traditional synthesis of metal-organic frameworks takes place in a solvent and at temperatures ranging from room temperature to approximately 250° C. Heat is transferred from a hot source, the oven, through convection. Alternatively, energy can be introduced through an electric potential, electromagnetic radiation, mechanical waves (ultrasound), or mechanically. The energy source is closely related to the duration, pressure, and energy per molecule that is introduced into a system, and each of these parameters can have a strong influence on the metal-organic framework formed and its morphology. A traditional synthesis is described by McDonald, T. M. et al. (2015) “Cooperative Insertion of CO₂ in Diamine Appended Metal-Organic Frameworks,” Nature, v.519, pp. 303-308, or Shearer, G. C. et al. (2016) “Defect Engineering: Tuning the Porosity and Composition of the Metal-Organic Framework UiO-66 via Modulated Synthesis,” Chem. Matter., v.28, pp. 3749-3761, incorporated herein by reference. Additional synthesis of making metal-organic frameworks is further described by McDonald, T. M., et al. (2012) “Capture of Carbon Dioxide from Air and Fluc Gas in the Alkylamine-Appended Metal-Organic Framework mmen-Mg₂(dobpdc),” J. Am. Chem. Soc., v.134, pp. 7056-7065; Shearer, G. C. et al. (2014) “Tuned to Perfection: Ironing Out the Defects in Metal-Organic Framework UiO-66,” Chem. Matter., v.26, pp. 4068-4071; Cavka, J. H. et al. (2008) “A New Zirconium Inorganic Building Brick Forming Metal Organic Frameworks with Exceptional Stability” J. Am. Chem. Soc., v.130, pp. 113850-13851; Milner, P. J. et al. (2018) “Overcoming Double-step CO₂ Adsorption and Minimizing Water Co-Adsorption in Bulky Diamine-Appended Variants of Mg₂(dobpdc),” Chem. Sci., v.9, pp. 160-174; in U.S. Pat. No. 8,653,292, and in US Patent Publication Nos. 2007/0202038, 2010/0307336, and 2016/0031920. Synthesis of EMM-71 is disclosed in WO2023/278246.

### High Solids Synthesis

Metal-organic frameworks can be produced in a high-solids synthesis using a pre-ligand as a ligand precursor, in the absence of a formamide solvent such as DMF, as disclosed in WO2023/278248. WO2023/278248 filed on Jun. 23, 2022, incorporated herein by reference, discloses alternative methods for the preparation of MOFs, including UiO-66 or EMM-71. For instance, a high-solids synthesis is disclosed for making MOFs in the absence of DMF, comprising reacting a pre-ligand with a metal component (forming a plurality of solid reactants), in the presence of a solvent, wherein at least 50 wt. % of the reaction mixture are the plurality of solid reactants. Also, WO2023/278248 discloses the use of divalent metals (e.g., Zn/Co) as crystallization aid to control crystal phase.

### Mixed Pre-Ligands or Pre-Ligand/Ligand Synthesis

In a first aspect, the present disclosure includes a method of making a metal-organic framework using a mixture of at least two different pre-ligands or of a pre-ligand with a ligand. More particularly, the present disclosure relates to a method of making a metal-organic framework comprising the steps of (a) combining a first pre-ligand and at least one of a second pre-ligand or a first ligand with a metal source comprising a metal component to provide a plurality of reactants; (b) adding a solvent to the plurality of reactants to form a reaction mixture; (c) heating the reaction mixture; and (d) cooling the reaction mixture to produce an insoluble portion and a soluble portion, wherein the insoluble portion comprises a plurality of metal-organic frameworks, each metal-organic framework comprising at least one ligand and the metal component.

In the first aspect of the present disclosure, the pre-ligands are derivatives or precursors of a linker (or ligand), e.g., of a terephthalate or fumarate linker, that can undergo a reaction, such as a hydrolysis or oxidation to form said linker, e.g., fumaric acid, terephthalic acid or a derivative thereof. More specifically, the pre-ligand can be any suitable linker derivative comprising a group such as a cyano, an amide or an ester group that can undergo a hydrolysis reaction to yield corresponding acid, a deprotonated form of corresponding acid, or a functionalized derivative thereof.

In the first aspect of the present disclosure, the first pre-ligand is selected from the group consisting of amides, cyano or methyl esters, in particular dimethylfumarate, dimethyl terephthalate, terephthalonitrile (1,4-dicyanobenzene), terephthalamide (1,4-benzenedicarboxamide), N¹,N⁴-dimethylterepthalamide, dimethyl 2-aminoterephthalate, dimethyl 2-nitroterephthalate, dimethyl 2-chloroterephthalate, dimethyl 2-bromoterephthalate, trimethyl 1,2,4-benzene tricarboxylate, trimethyl 1,3,5-benzene tricarboxylate, tetramethyl 1,2,4,5-benzene tetracarboxylate, polyethylene terephthalate, and mixtures thereof. More particularly, the first pre-ligand can be at least one of dimethylfumarate, polyethylene terephthalate, or a methyl ester terephthalate or a derivative thereof, such as dimethyl terephthalate, dimethyl 2-aminoterephthalate, dimethyl 2-nitroterephthalate, dimethyl 2-chloroterephthalate, or dimethyl 2-bromoterephthalate. In addition or in the alternative, the pre-ligand is a fumarate ester, such as dimethylfumarate, or a terephthalate ester, such as dimethylterephthalate.

In a first embodiment of the first aspect, step (a) comprises combining the first ligand with a second pre-ligand selected from the group consisting of C2 to C10, preferably a C2 to C8, linear or branched alkyl esters of fumarate, terephthalate, 2-aminoterephthalate, 2-nitroterephthalate, 2-chloroterephthalate, 2-bromoterephthalate, 1,2,4-benzene tricarboxylate, 1,3,5-benzene tricarboxylate, 1,2,4,5-benzene tetracarboxylate, and mixtures thereof. The C2 to C10 linear and branched alkyl groups may optionally be functionalized with an oxygenate, a nitrogen and/or a halide functionality. Especially suitable alkyl groups are ethyl, octyl, and 2-ethylhexyl. For instance, in the case of esters of terephthalate, the second pre-ligand may be a compound of the following formula:

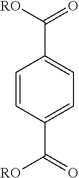

wherein both R groups are the same or different, in particular the same, and are selected from C2 to C10 linear or branched (optionally functionalized) alkyl groups. Especially suitable examples of such compounds are those for which R is selected from the group consisting of ethyl, octyl, and 2-ethylhexyl, such as diethylterephthalate (DET), dioctylterephthalate (DOT) and diethylhexylterephthalate (DEHT).

In a particularly preferred embodiment, the second pre-ligand may be a liquid at 20° C., such as dioctylterephthalate (DOT) and diethylhexylterephthalate (DEHT). This allows for improving the rheological properties of the reaction mixture, allowing for easier mixing (agitation benefits). It is also advantageous in that by-products resulting from the conversion of the pre-ligand are not water soluble (e.g., 2-ethyl hexanol, bis(2-ethylhexyl eter), 2-ethylhexyl acetate)

In this first embodiment, the first and second pre-ligands may be converted in step (c) into second and third ligands, with the second and third ligands being the same or different, preferably the same. For instance, the first pre-ligand might be dimethylfumarate and the second pre-ligand might be a C2 to C10 linear or branched alkyl ester of fumarate, both first and second pre-ligands being converted into fumaric acid in step (c) and the second and third ligands are the same. In another example, the first pre-ligand might be dimethylterephthalate and the second pre-ligand might be a C2 to C10 linear or branched alkyl ester of terephthalate, both first and second pre-ligangs being converted into terephthalic acid in step (c) and the second and third ligands are the same.

In this first embodiment, the mole ratio of the second pre-ligand to the first pre-ligand may be from greater than 0 to 0.6, such as from 0.05 to 0.5, or from 0.1 to 0.5, for instance from 0.2 to 0.4.

The use of a second pre-ligand bearing esters of C2 to C10 alkyl groups allows for improved pore volume, e.g., from less than 0.7 to more than 0.7 cc/g. Increased pore volume is indicative of increase in REO domain %.

In a second embodiment of the first aspect, step (a) comprises combining the first pre-ligand with a first ligand selected from the group consisting of fumaric acid, terephthalic acid (or benzene dicarboxylic acid (BDC)), 2-aminoterephthalic acid, 2-nitroterephthalic acid, 2-chloroterephthalic acid, 2-bromoterephthalic acid, 1,2,4-benzene tricarboxylic acid, 1,3,5-benzene tricarboxylic acid, 1,2,4,5-benzene tetracarboxylic acid, and mixtures thereof. In particular, the first ligand can be at least one of fumaric acid and terephthalic acid or a derivative thereof, more particularly terephthalic acid.

In this second embodiment, the first pre-ligand is converted in step (c) into a second ligand that may be the same or different than the first ligand, preferably the same. For instance, the first pre-ligand might be dimethylfumarate and the first ligand might be fumaric acid, the first pre-ligand being converted into fumaric acid in step (c) so that the second and first ligands are the same. In another example, the first pre-ligand might be dimethylterephthalate and the first ligand might be terephthalic acid, the first pre-ligand being converted into terephthalic acid in step (c) so that the second and first ligands are the same.

In this second embodiment, the mole ratio of the second pre-ligand to the first pre-ligand may be from greater than 0 to 0.6, such as from 0.05 to 0.5, or from 0.1 to 0.5, for instance from 0.2 to 0.4.

The use of a pre-ligand in combination with ligand allows for reducing the amounts of by-products derived from the pre-ligand hydrolysis, such as dimethyl ether, methyl acetate and methanol in the case of methyl esters. The combination of a pre-ligand with a ligand is also advantageous in that it allows for decreasing the costs while the effect on product quality, including pore volume, is limited.

In a third embodiment, the first pre-ligand might be combined with both a second pre-ligand and a first ligand as defined above. In this third embodiment, the first and second pre-ligands might be converted in step (c) into second and third ligand that may be the same or different, and that may be the same or different from first ligand. More particularly the first, second and third ligands in step (c) are the same.

In this third embodiment, the mole ratio of the second pre-ligand and first ligand to the first pre-ligand may be from greater than 0 to 0.6, such as from 0.05 to 0.5, or from 0.1 to 0.5, for instance from 0.2 to 0.4.

In both the first and second embodiments of the first aspect, the metal source comprises a metal component. The metal component can be a tetravalent metal such as zirconium, cerium, hafnium and titanium, or a mixture thereof, preferably Zr or Zr/Hf. Preferably, the metal source can generate the metal component, in particular as a tetravalent cation, in solution. Suitable examples of metal sources include metal oxide, chloride, nitrate or sulfate salt, a hydrate thereof, or an oxyanion salt thereof, such as, but not limited to, zirconium tetrachloride, zirconyl chloride, zirconyl nitrate, zirconyl sulfate, cerium ammonium nitrate, cerium nitrate, titanium tetrachloride, titanium oxysulfate, hafnium tetrachloride, hafnium oxychloride, hafnium oxynitrate, or hafnium oxysulfate. In an aspect, the tetravalent cation to ligand mol ratio may be between about 1.75:1 and about 1:1.75.

In both the first and second embodiments of the first aspect, the first pre-ligand and the at least one of a second pre-ligand or a first ligand are combined with the metal source comprising a metal component to provide a plurality of reactants, and solvent is added to said plurality of reactants to form a reaction mixture wherein at least 50 wt. % of the reaction mixture is the plurality of reactants. In a further embodiment, the reaction mixture may comprise from 50 wt. % to 90 wt. % of the plurality of reactants, in particular at least 60 wt. %, such as at least 65 wt. %, or at least 70 wt. % of the plurality of reactants. For instance, solvent can be added to the reaction mixture in step (b) in an amount between about 0.1 and about 1.0 weight equivalents relative to the plurality of reactants, preferably less than 1.0. For example, solvent is added to the reaction mixture in weight equivalents relative to the plurality of reactants in an amount between about 0.1 and about 0.9, between 0.1 and 0.8, between 0.1 and 0.7, between 0.1 and 0.6, between 0.1 and 0.5, between 0.1 and 0.4, between 0.1 and 0.3, or between 0.1 and 0.2. In cases where the second pre-ligand is a solid component, the plurality of reactants corresponds to solid reactants and the amount of solvent that can be added to the reaction mixture in step (b) may be expressed in an amount relative to the solid reactants, similar to the ranges defined above.

In both the first and second embodiments of the first aspect, the solvent of step (b) may typically include at least one of a monocarboxylic acid and/or a mineral acid, and optionally water. Suitable examples of monocarboxylic acids include acetic acid (e.g., glacial acetic acid) and analogues thereof, such as formic acid, propionic acid, and mixtures thereof. Suitable examples of mineral acids include hydrochloric acid and analogues thereof, such as hydrobromic acid.

When the solvent comprises a monocarboxylic acid, the mole ratio of monocarboxylic acid to ligand(s) in the reaction mixture is preferably from 1:1 to 20:1, in particular from 1:1 to less than 20:1. In this embodiment, the expression “amount of ligand(s)” corresponds to the amount of ligand resulting from the conversion of the pre-ligand(s) during the heating step and of potential ligand that was added in the reaction mixture as starting material, e.g., the amount of fumaric acid or terephthalic acid (or deprotonated form or functionalized derivative thereof) resulting from the hydrolysis of corresponding fumarate ester(s) or terephthalate ester(s) (or derivative thereof) and optionally present in the reaction mixture as starting material. More particularly, the amount of monocarboxylic acid (e.g., acetic acid) to ligand(s) (expressed as mol ratio) may be equal to or less than about 20:1, 19:1, 18:1, 17:1, 16:1, 15:1, 14:1, 13:1, 12:1, 11:1, and equal to or more than about 1:1, 2:1, 3:1, 4:1, 5:1, 6:1, 7:1, 8:1, 9:1 or 10:1. For instance, the amount (as mol ratio) of monocarboxylic acid to ligand(s) in the reaction mixture may be from 1:1 to 10:1, or from 2:1 to 8:1, such as from 3:1 to 5:1.

In the first aspect of the present disclosure, when the solvent comprises a mineral acid, in the alternative or in addition to a monocarboxylic acid, the mol ratio of mineral acid to ligand(s) in the reaction mixture is preferably at most 5:1. More particularly, the amount of mineral acid (e.g., HCl) to ligand(s) (expressed as mole ratio) may range from 1:10 to 5:1, or from 1:2 to 3:1, such as from 1:1 to 2:1.

### Alternative Metal Sources

In a second aspect, the present disclosure includes a method of making a metal-organic framework using alternative metal sources. More particularly, the present disclosure relates to a method of making a metal-organic framework comprising the steps of (a) combining a pre-ligand with a metal source comprising a metal component to provide a plurality of reactants, wherein the metal source is selected from the group consisting of metal hydroxides, metal acetates, metal hydroxyacetates, metal carbonates, metal hydroxycarbonates, and mixtures thereof; (b) adding a solvent to the plurality of reactants to form a reaction mixture; (c) heating the reaction mixture wherein the pre-ligand is converted to a ligand in the reaction mixture and the ligand reacts with the metal component; and (d) cooling the reaction mixture to produce an insoluble portion and a soluble portion, wherein the insoluble portion comprises a plurality of metal-organic frameworks, each metal-organic framework comprising at least one ligand and the metal component.

In the second aspect of the present disclosure, the pre-ligand is a derivative or precursor of a linker (or ligand), e.g., of a terephthalate or fumarate linker, that can undergo a reaction, such as a hydrolysis or oxidation to form said linker, e.g., fumaric acid, terephthalic acid or a derivative thereof. More specifically, the pre-ligand can be any suitable linker derivative comprising a group such as a cyano, an amide or an ester group that can undergo a hydrolysis reaction to yield corresponding acid, a deprotonated form of corresponding acid, or a functionalized derivative thereof. More specifically the pre-ligand may be selected from the group consisting of amides, cyano or methyl esters, in particular dimethylfumarate, dimethyl terephthalate, terephthalonitrile (1,4-dicyanobenzene), terephthalamide (1,4-benzenedicarboxamide), N¹,N⁴-dimethylterepthalamide, dimethyl 2-aminoterephthalate, dimethyl 2-nitroterephthalate, dimethyl 2-chloroterephthalate, dimethyl 2-bromoterephthalate, trimethyl 1,2,4-benzene tricarboxylate, trimethyl 1,3,5-benzene tricarboxylate, tetramethyl 1,2,4,5-benzene tetracarboxylate, polyethylene terephthalate, and mixtures thereof. More particularly, the pre-ligand can be at least one of dimethylfumarate, polyethylene terephthalate, or a methyl ester terephthalate or a derivative thereof, such as dimethyl terephthalate, dimethyl 2-aminoterephthalate, dimethyl 2-nitroterephthalate, dimethyl 2-chloroterephthalate, or dimethyl 2-bromoterephthalate. In addition or in the alternative, the pre-ligand is a fumarate ester, such as dimethylfumarate, or a terephthalate ester, such as dimethylterephthalate. In a further embodiment, the pre-ligand can be used in the form of a first pre-ligand in combination with at least one of a second pre-ligand or a first ligand, as defined in the first aspect of the invention disclosed herein.

In the second aspect, the metal source is selected from the group consisting of metal hydroxides, metal acetates, metal hydroxyacetates, metal carbonates, metal hydroxycarbonates, and mixtures thereof. The metal component can be a tetravalent metal such as zirconium, cerium, hafnium and titanium, or a mixture thereof, preferably Zr or Zr/Hf. Preferably, the metal source can generate the metal component, in particular as a tetravalent cation, in solution. By way of example, when the metal component is zirconium, the metal source may be selected from zirconium hydroxide (Zr(OH)₄), zirconium acetate (Zr(OAc)₄), zirconium acetate hydroxide (Zr(OAc)ₓ(OH)_{y} where x+y is about 4), zirconium carbonate Zr(CO₃)₂, and/or zirconium hydroxycarbonate (Zr(OH)₂CO₃ZrO₂), in particular zirconium hydroxide. In an aspect, the tetravalent cation to ligand mol ratio may be between about 1.75:1 and about 1:1.75.

In the second aspect, the pre-ligand is combined with the metal source comprising a metal component to provide a plurality of reactants, and solvent is added to said plurality of reactants to form a reaction mixture wherein between 15 wt. % and 50 wt. % of the reaction mixture is the plurality of reactants. In a further embodiment, the reaction mixture may comprise from 25 wt. % to less than 50 wt. % of the plurality of reactants, in particular from 30 wt. % to less than 50 wt. % of the plurality of reactants, for instance from 30 wt. % or from 35 wt. % to 45 wt. % of the plurality of reactants. For instance, solvent may be added to the reaction mixture in step (b) in an amount between about 1.0 and about 4.0 weight equivalents relative to the plurality of reactants, for example, between from greater than 1.0 to 3.0, or from 1.2 to 2.5. In cases where the pre-ligand is a solid component, the plurality of reactants corresponds to a plurality of solid reactants and the amount of plurality of reactants in the reaction mixture may be expressed as an amount of solids reactants in the reaction mixture, with similar ranges as defined above. Similarly, in that case, the amount of solvent that can be added to the reaction mixture in step (b) may be expressed in an amount relative to the solid reactants, similar to the ranges defined above.

The solvent of step (b) may typically include at least one of a monocarboxylic acid and/or a mineral acid, and optionally water, preferably at least one of a monocarboxylic acid and a mineral acid, and optionally water. Suitable examples of monocarboxylic acids include acetic acid (e.g., glacial acetic acid) and analogues thereof, such as formic acid, propionic acid, and mixtures thereof. Suitable examples of mineral acids include hydrochloric acid and analogues thereof, such as hydrobromic acid.

When the solvent comprises a monocarboxylic acid, the mole ratio of monocarboxylic acid to ligand in the reaction mixture is preferably from 1:1 to 20:1, in particular from 1:1 to less than 20:1. In this embodiment, the expression “amount of ligand” corresponds to the amount of ligand resulting from the conversion of the pre-ligand during the heating step, e.g., the amount of fumaric acid or terephthalic acid (or deprotonated form or functionalized derivative thereof) resulting from the hydrolysis of corresponding fumarate ester or terephthalate ester (or derivative thereof). More particularly, the amount of monocarboxylic acid (e.g., acetic acid) to ligand (expressed as mol ratio) may be equal to or less than about 20:1, 19:1, 18:1, 17:1, 16:1, 15:1, 14:1, 13:1, 12:1, 11:1, and equal to or more than about 1:1, 2:1, 3:1, 4:1, 5:1, 6:1, 7:1, 8:1, 9:1 or 10:1. For instance, the amount (as mol ratio) of monocarboxylic acid to ligand in the reaction mixture may be from 1:1 to 10:1, or from 2:1 to 8:1, such as from 3:1 to 5:1.

When the solvent comprises a mineral acid, in the alternative or in addition to a monocarboxylic acid, the mol ratio of mineral acid to ligand in the reaction mixture is preferably at least 1:1. More particularly, the amount of mineral acid (e.g., HCl) to ligand (expressed as mol ratio) may range from 1:1 to 20:1, or from 1:1 to 10:1, such as from 2:1 to 8:1, most particularly from greater than 2:1 to 6:1.

When the solvent comprises both a monocarboxylic acid and a mineral acid, the mol ratio of mineral acid to monocarboxylic acid in the reaction mixture is preferably at most 8:1. More particularly, the amount of mineral acid (e.g., HCl) to monocarboxylic acid (e.g., acetic acid) (expressed as mol ratio) may range from 1:5 to 8:1, in particular from 1:4 to 6:1, or from 1:3 to 5:1, such as from 1:2 to 4:1, or from 3:4 to 3:1 or to 2:1.

The methods of the second aspect of the present disclosure are advantageous in that the use of the alternative metal sources allows for the preparation of MOFs in the presence of at least 50 wt. % solvent but in the absence of a formamide solvent, in particular without DMF (i.e., in each and every of steps (a)-(d)). In addition, the use of the alternative metal sources results in MOFs having a smaller particle size and a narrower particle size distribution. Also, it has been found that, in the second aspect of the present disclosure, using a higher amount of mineral acid in terms of mol ratio of mineral acid to ligand and/or of mineral acid to monocarboxylic acid allows for the preparation of MOFs with increased pore volume and REO domain %.

### General Disclosure Applicable to the First and Second Aspects of the Disclosure

In a preferred embodiment of the first and second aspects of the present disclosure, the method (i.e., each and every of steps (a)-(d)) is conducted in the absence of a formamide solvent, in particular without DMF. More particularly, the reaction mixtures used in the present methods are free of a formamide solvent, such as dimethylformamide (DMF).

In the first and second aspects described herein, as part of the heating step (c), the reaction mixture is heated at a temperature and for a time sufficient to convert the pre-ligand(s) into ligand(s) and for said ligand(s) to react with the metal component. The heating step can include heating the sealed reaction mixture in static conditions for at least 4 to 6 hours. The heating step can also include heating the sealed reaction mixture under dynamic (e.g., stirred, shaken, mixed, agitated) conditions for, e.g., up to about 24 hours. The heating step can include heating the sealed reaction mixture in a static or rotating oven between about 70° C. to about 180° C. Heating can also be performed without sealing, with the MOF synthesized with the solvent(s) at reflux under approximately 1 bar of pressure. In an aspect, the reaction mixture is generally heated to a temperature of from 70° C. to 220° C., such as from 100° C. to 220° C., or from about 70° C. to about 160° C., from 100° C. to 160° C., from 140° C. to 160° C., e.g., about 70° C., about 100° C., about 130° C., about 150° C., or about 160° C. for at least 4 hours to 7 days, or 6 hours to 5 days, or 12 hours to 3 days.

In the first and second aspects described herein, after cooling in step (d) to, e.g., room temperature, an insoluble portion and a soluble portion are produced, the insoluble portion comprising a plurality of the metal-organic frameworks. The present methods may further comprise separating the insoluble portion from the soluble portion and drying the insoluble portion to produce a plurality of the metal-organic frameworks. This can be done by any standard mean. For instance, the reaction mixture can be centrifuged or filtered to obtain the metal-organic frameworks.

The methods of the first and second aspects described herein may further comprise washing the metal-organic framework material separated from the reaction mixture by any standard means, for instance, the metal-organic framework material may be washed by a solvent such as DMF, methanol, ethanol, acetone and/or water, e.g., to remove excess organic ligand. The metal-organic framework material may also be washed in slightly basic solutions, for instance borate or formate solutions, such as sodium borate or sodium formate, to remove pendant ligands.

The methods of the first and second aspects described herein are especially suitable for the preparation of zirconium-based, titanium-based, cerium-based and/or hafnium-based metal-organic frameworks, in particular, Zr-based (or Zr/Hf-based) metal-organic frameworks, more particularly Zr-(or Zr/Hf-) metal-organic frameworks constructed from polytopic carboxylates, even more particularly Zr- (or Zr/Hf-) terephthalate metal-organic frameworks and/or Zr- (or Zr/Hf-) fumarate metal-organic frameworks. For instance, the present methods may be used for the preparation of metal-organic frameworks selected from the group consisting of UiO-66, EMM-71, Zr-Fumarate, UiO-67, MOF-808, NU-1000, or a functionalized derivative thereof.

It is integral that the quality of MOF is not sacrificed through the scale up process. Several characterization techniques, described in detail below, show that the novel methods disclosed herein produce similar or superior quality MOFs when compared to traditional solvent-based synthesis and/or high-solids synthesis.

Aspects of the disclosure are described in greater detail by way of specific examples. The following examples are offered for illustrative purposes and are not intended to limit the disclosure in any manner. Those of skill in the relevant art will readily recognize a variety of parameters can be changed or modified to yield essentially the same results.

### EXAMPLES

The features of the disclosure are described in the following non-limiting examples.

In these examples, the X-ray diffraction (XRD) patterns of the materials were recorded on either a Panalytical XPert Pro powder X-ray diffractometer fitted with an Anton Paar HTK-16N environmental stage equipped with a Pt-strip heater, or a Bruker D8 Envdevor instrument in continuous mode using a Cu Kα radiation, Bragg-Bentano geometry with Lynxeye detector, in the 20 range of 2 to 60°. In both cases, the interplanar spacings, d-spacings, were calculated in Angstrom units. The intensities are uncorrected for Lorentz and polarization effects. The location of the diffraction peaks in 2-theta, and the relative peak area intensities of the lines, I/I(o), where Io is the intensity of the strongest line, above background, were determined with the MDI Jade peak fitting algorithm using a 3rd order polynomial background fit. It should be understood that diffraction data listed as single lines may consist of multiple overlapping lines which under certain conditions, such as differences in crystallographic changes, may appear as resolved or partially resolved lines. Typically, crystallographic changes can include minor changes in unit cell parameters and/or a change in crystal symmetry, without a change in the framework connectivity. These minor effects, including changes in relative intensities, can also occur as a result of differences in cation content, framework composition, nature and degree of pore filling, crystal size and shape, preferred orientation and thermal and/or hydrothermal history. All samples were analyzed as is and without any further grinding.

The relative intensity is measured by the method of Shearer, G. C. et al., Defect Engineering: Tuning the Porosity and Composition of the Metal-Organic Framework UiO-66 via modulated Synthesis, Chem. Mater., v.28(11), pp. 3749-3761, 2016. Relative intensity is characteristic of the degree of defects, in particular of node defects, in the framework. As detailed in Shearer et al., relative intensity of the broad peak (i.e., between 3 and 7° 2θ) is a quantitative descriptor for the concentration of missing cluster defects in the framework, e.g., in the UiO-66 framework. Relative intensity is calculated as the integrated intensity of the broad peak (around 5° 20, such as between 2 and 7° 2θ, i.e., corresponding to the aggregate integrated intensity of the (100) and (110) peaks in the present invention) divided by the average of the intensity of the (111), (200), and (600) peaks which corresponds respectively to peaks at about 7.4, 8.5 and 25.8° 2θ.

$$Relative Intensity = \frac{I ( broad peak )}{[ ( I ( 111 ) + I ( 200 ) + I ( 600 ) ) / 3 ]}$$

The peak width ratio is the ratio between the calculated peak width at half maximum (as calculated by the MDI Jade peak fitting algorithm) of the (110) peak and the (111) peak occurring at ˜6 and 7.4° 20.

The scanning electron microscopy (SEM) images of the as-synthesized materials were obtained on either a Hitachi 4800 Scanning Electron Microscope or a Thermo Scientific Apreo Scanning Electron Microscope.

The median and mean particle sizes and the particle size distribution of the materials can be determined using methods known in the relevant art, for example, by laser sizing. The particle size distribution data were obtained from a Horiba Scientific particle size analyzer.

The total pore volume of the materials can be determined using methods known in the relevant art. For example, the porosity of the materials can be determined by nitrogen adsorption at 77K at 0.8 P/P₀. measured with nitrogen physisorption.

### Comparative Example 1: Solvent-Based Synthesis of EMM-71

EMM-71 was synthesized following the method of WO2023/278246. In this solvent-based synthesis, the EMM-71 metal-organic frameworks were made with 100 milligrams (mg) of cobalt II chloride (CoCl₂), 350 mg of benzene dicarboxylic acid (BDC), 680 mg of zirconium (IV) oxychloride octahydrate (ZrOCl₂), and 10 milliliter (mL) of a solvent comprising 50 percent by volume of DMF and 50 percent by volume of glacial acetic acid at a temperature of about 100° C.

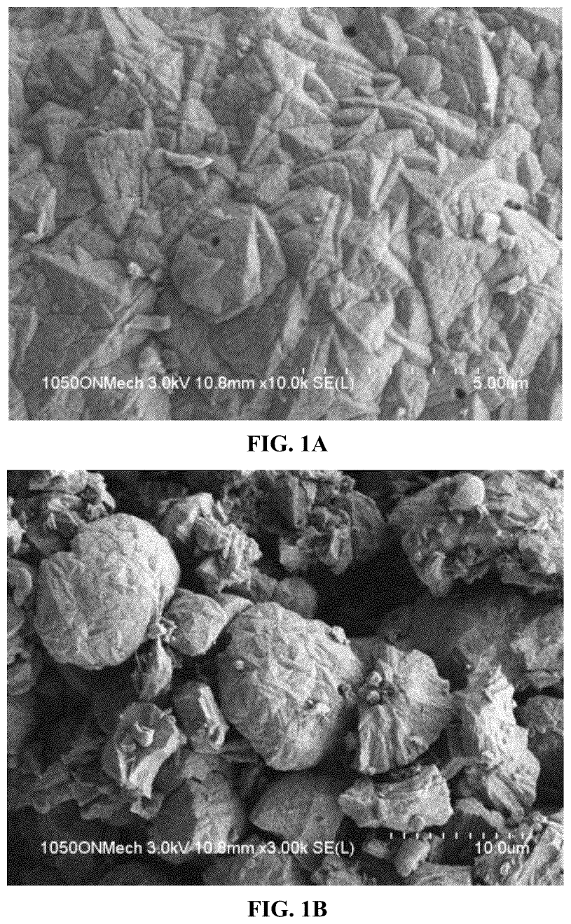

FIG. 1A and FIG. 1B are SEM micrographs (images) of the EMM-71 of comparative example 1. The images were taken at 5 μm (FIG. 1A) and at 10 μm (FIG. 1B) scale, respectively. Large polycrystalline particles were made (approximately 10 μm) having high porosity. However, when tested, the metal-organic frameworks provided limited adsorption of decalin due to large crystal sizes or the intergrown nature of the crystallites, thereby producing surface diffusion limitations.

### Comparative Example 2: High-Solids Synthesis of EMM-71

EMM-71 was synthesized following the method of WO2023/278248. In this high-solids synthesis, the EMM-71 metal-organic frameworks were made by reacting 78.8 grams (g) of dimethyl terephthalate (DMT) and 192.57 g of zirconium (IV) oxychloride octahydrate (ZrOCl₂) in 29.2 mL of hydrochloric acid (˜37 wt. %) and 81.6 mL of glacial acetic acid.

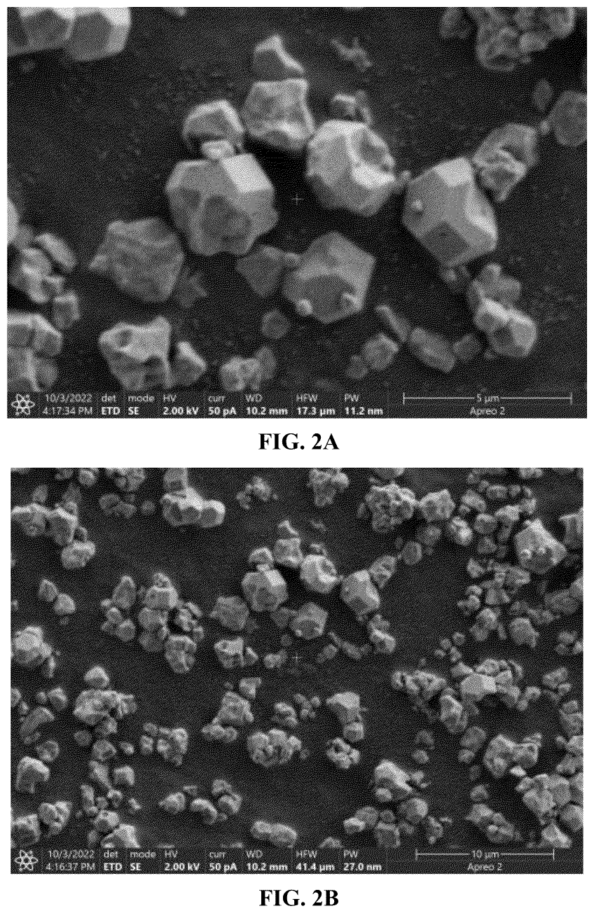

FIG. 2A and FIG. 2B are SEM micrographs (images) of the EMM-71 of comparative example 2 taken at 5 μm (FIG. 2A) and at 10 μm (FIG. 2B) scale, respectively. As shown, the particles produced in the high-solids synthesis are smaller than those produced in the solvent-based system. The size of the particles are more uniform and the metal-organic frameworks have increased porosity (comparable to that produced by the solvent-based syntheses). Conversely, many of the traditional synthesis designed to adjust particles sizes cannot produce similar results.

### Example 1A to 1F: Synthesis of EMM-71 with a Mixture of Dimethylterephthalate (DMT) and Diethylterephthalate (DET)

For a given reaction, 2.64 g of zirconium oxychloride octahydrate and 0.84 g of hafnium oxychloride hydrate, resulting in a 80/20 mixture (expressed by moles) of ZrOCl₂ and HfOCl₂, were mixed with 6.8 mmol of total terephthalate with the following DET/DMT compositions: 0 mol % DET (example 1A), 10 mol % DET (example 1B), 20 mol % DET (example 1C), 40 mol % DET (example 1D), 60 mol % DET (example 1E), and 80 mol % DET (example 1F). For example, for 0% DET (Example 1A), 1.35 g of DMT was used. For a terephthalate mixture DET/DMT with 40 mol % DET (Example 1D), 0.81 g of DMT and 0.606 g of DET were used. This physical mixture was then wetted with 1.5 mL of glacial acetic acid and 0.5 mL of hydrochloric acid (˜37 wt. %). This mixture was then agitated until homogenous and loaded into a Teflon-lined 23 mL acid digestion vessel. The vessels were loaded in a room-temperature rotating oven and heated to 80° C. and held for 5 hours. The temperature was then increased to 150° C. and that was held for an additional 10-18 hours.

The reaction mixtures were then cooled, and the solids suspended in 25 mL of water, pH adjusted to 3.5 with sodium formate and heated for 2 hours at 85° C. The solution was then filtered, washed with 75-150 mL of 0.05 M formic acid and 75-150 mL of ethanol. This wet cake was then dried to obtain dry EMM-71.

FIG. 3 shows the powder X-ray diffraction patterns of the EMM-71 materials of examples 1A to 1F. It can be seen from said XRD patterns that good quality EMM-71 materials were obtained for all of examples 1A to 1F.

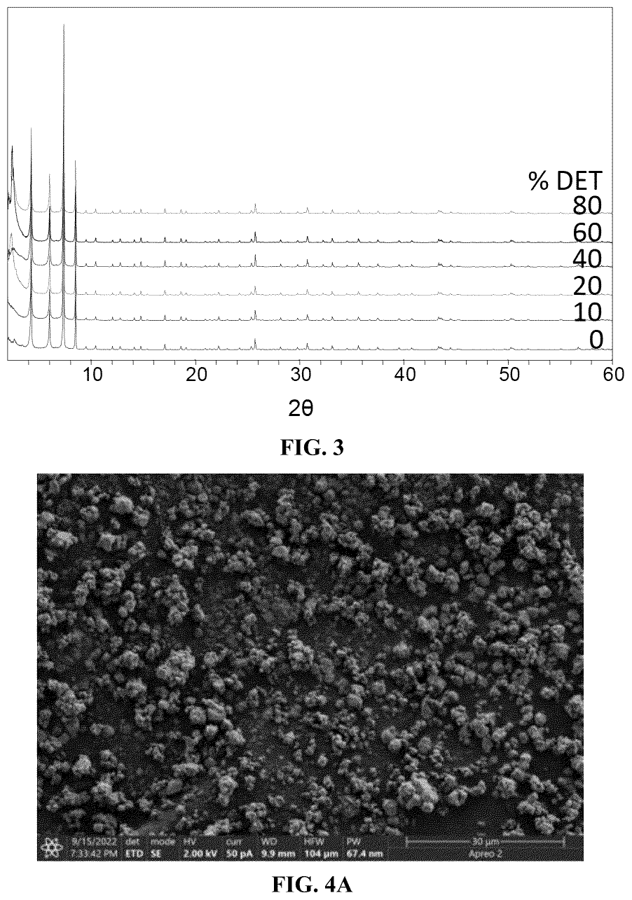

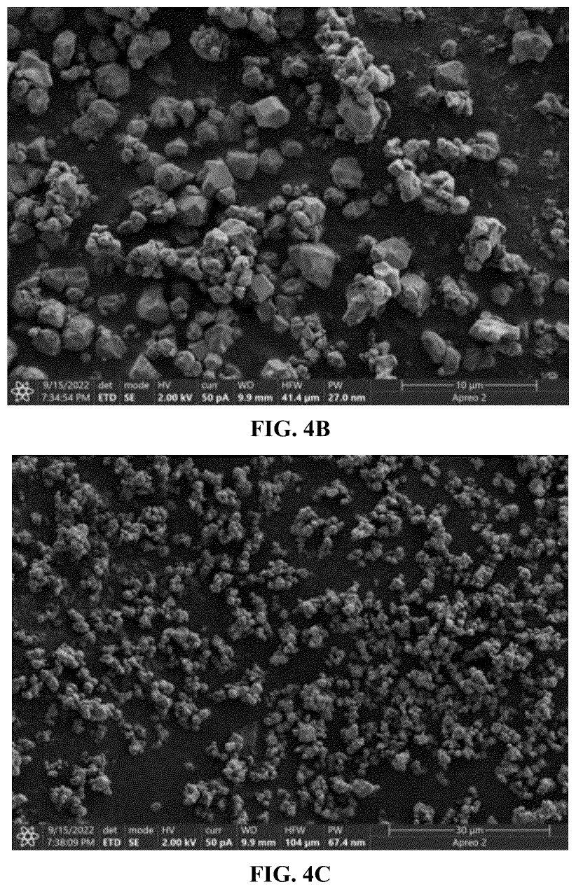

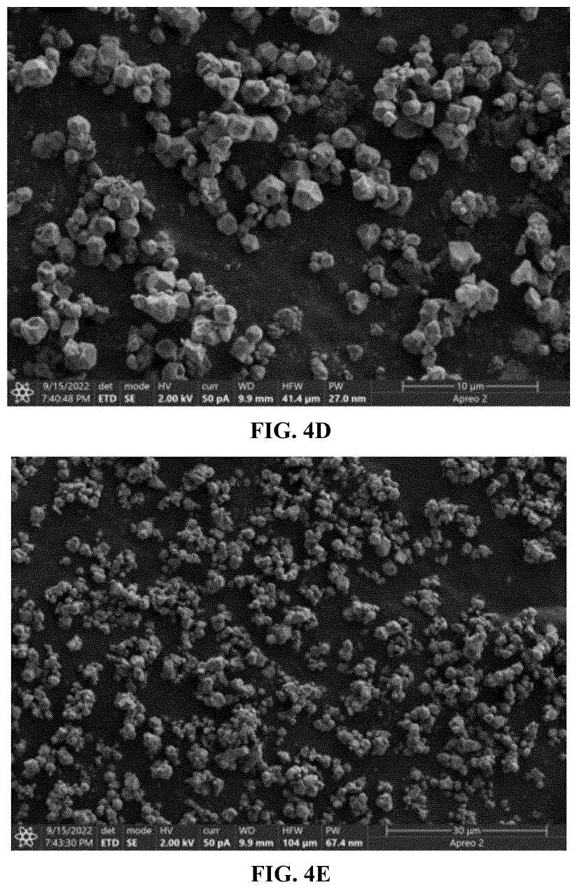

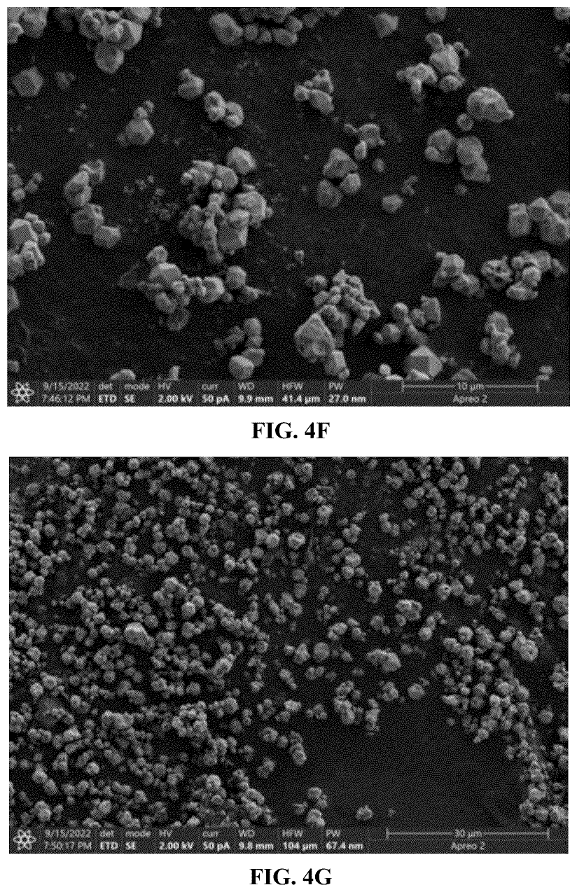

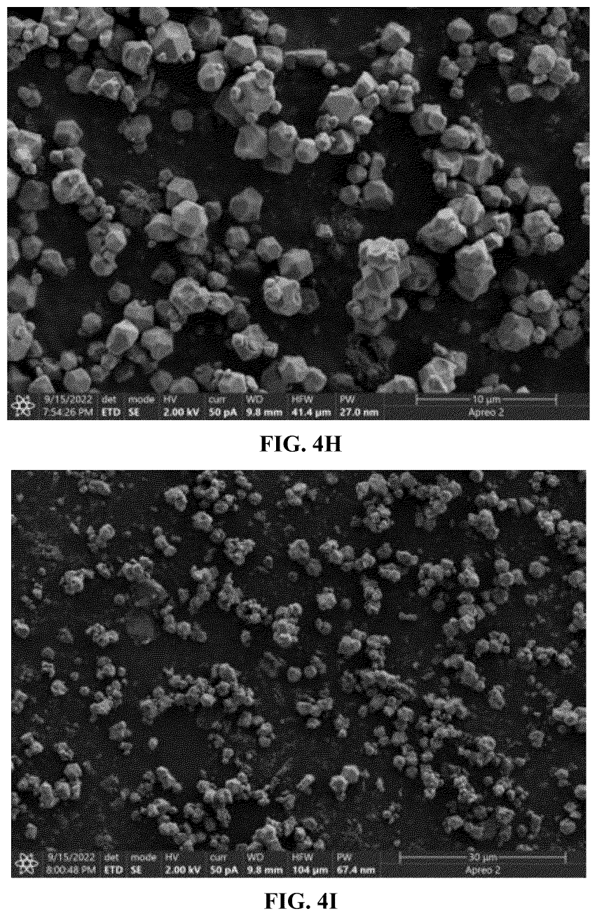

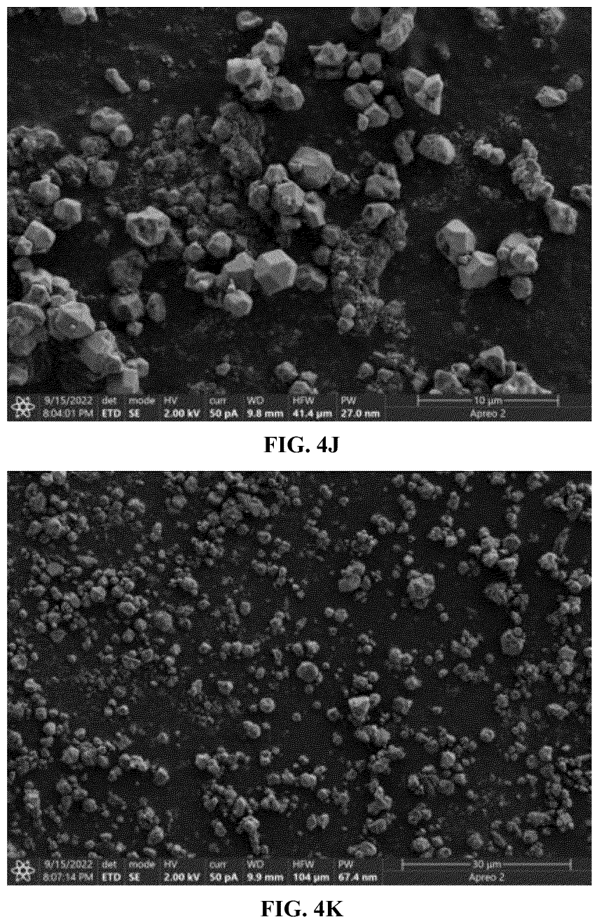

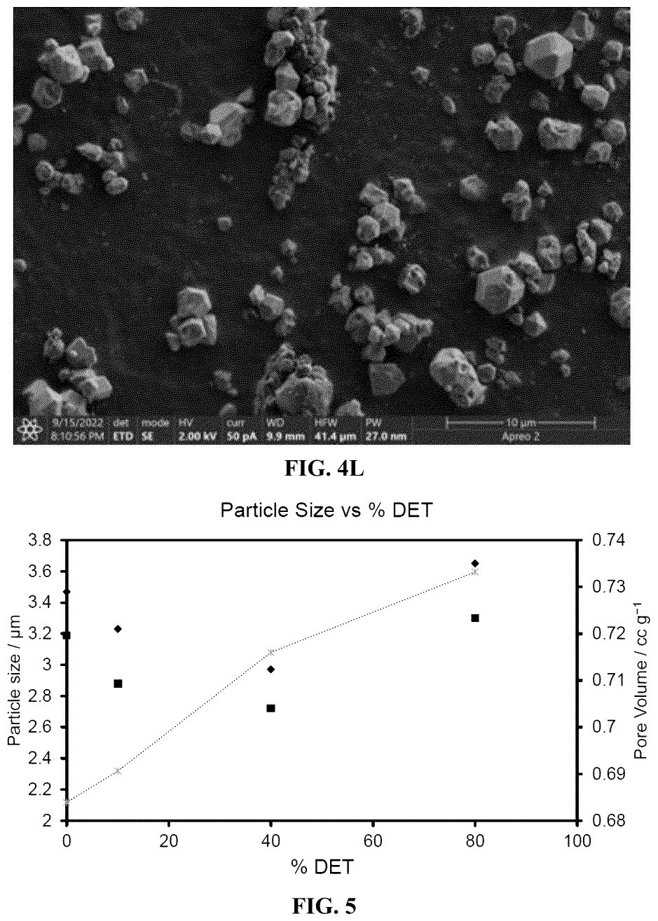

FIG. 4A to 4L are SEM micrographs of the EMM-71 materials of example 1A to 1F at respectively 30 and 10 μm scale. More particularly, FIG. 4A-4B correspond to example 1A (0 mol % DET), FIG. 4C-4D correspond to example 1B (10 mol % DET), FIG. 4E-4F correspond to example 1C (20 mol % DET), FIG. 4G-4H correspond to example 1D (40 mol % DET), FIG. 4I-4J correspond to example 1E (60 mol % DET), and FIG. 4K-4L correspond to example 1F (80 mol % DET).

FIG. 5 is a plot of the mean (▪) and median (♦) particles size as measured by laser sizing for the EMM-71 materials of examples 1A (0 mol % DET), 1B (10 mol % DET), 1D (40 mol % DET) and 1F (80 mol % DET).

The line in FIG. 5 represents the pore volume (cc/g) of the EMM-71 materials of examples 1A (0 mol % DET), 1B (10 mol % DET), 1D (40 mol % DET) and 1F (80 mol % DET), as measured by nitrogen adsorption at 77K at 0.8 P/P₀.

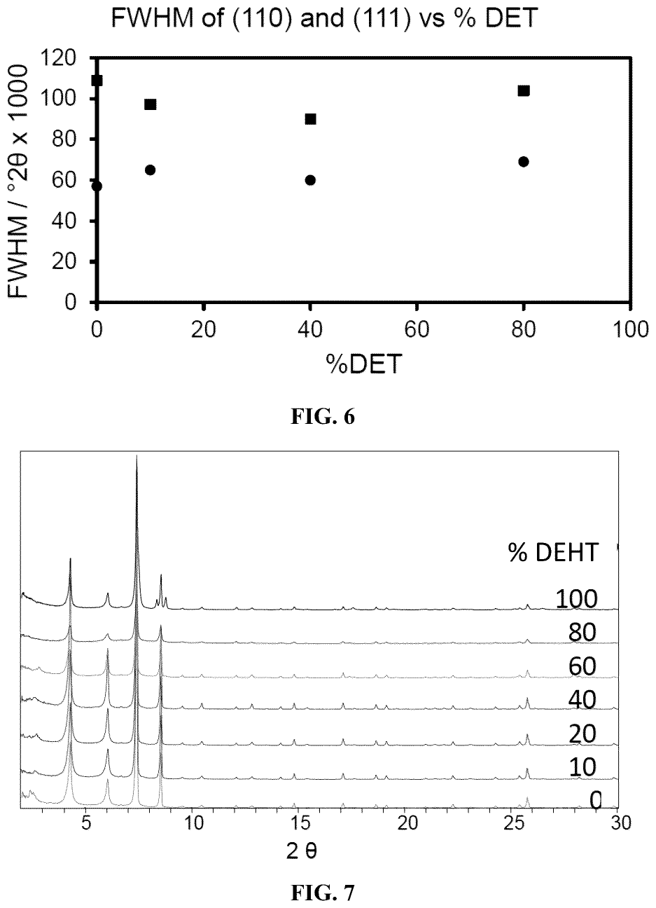

FIG. 6 is a plot of the full width at half maximum (FWHM) of the (111) (●) and (110) (▪) peaks of the EMM-71 materials of examples 1A (0 mol % DET), 1B (10 mol % DET), 1D (40 mol % DET) and 1F (80 mol % DET).

It can be seen from examples 1A to 1F that the use of DET as a second pre-ligand in combination with DMT as a first pre-ligand in the reaction mixture influences the particle size of the metal-organic frameworks produced. In particular, the median and mean particle sizes decrease for an amount of about 10 to 50 mol % DET. Also, examples 1A to 1F show that the pore volume of the metal-organic framework increases with increasing amounts of DET present in the reaction mixture. While these pore volume increases may seem modest, these are actually indicative of significant increase in the REO domain %. FWHM of the (110) and (111) peaks of the EMM-71 materials examples 1A, 1B, 1D and 1F show that the peak width ratio (i,e, the ratio between the calculated peak width at half maximum of the (110) peak and the (111) peak) is much lower when some DET is present (e.g., from 10 to 80 mol % DET).

### Examples 2A to 2G: Synthesis of EMM-71 with a Mixture of Dimethylterephthalate (DMT) and Dicthylhexylterephthalate (DEHT)

For a given reaction, 3.3 g of zirconium oxychloride octahydrate was mixed with 6.8 mmol of total terephthalate with the following DEHT/DMT compositions: 0 mol % DEHT (example 2A), 10 mol % DEHT (example 2B), 20 mol % DEHT (example 2C), 40 mol % DEHT (example 2D), 60 mol % DEHT (example 2E), 80 mol % DEHT (example 2F), and 100 mol % DEHT (example 2G). For example, for 0 mol % DEHT (example 2A), 1.35 g of DMT was used. For 40 mol % DEHT (example 2D), 0.81 g of DMT and 1.064 g of DEHT were used. The pre-ligands were then combined with 1.5 mL of glacial acetic acid and 0.5 mL of hydrochloric acid. The mixture was then agitated until homogenous and loaded into a Teflon-lined 23 mL acid digestion vessel. The vessels were loaded in a room-temperature rotating oven and heated to 80° C. for 5 hours. The temperature was then increased to 150° C. for an additional 10-18 hours.

The reaction mixtures were cooled and the solids suspended in 25 mL of water. The pH was adjusted to 3.5 with sodium formate and heated for 2 hours at 85° C. The solution was filtered and washed with 75-150 mL of 0.05 M formic acid and 75-150 mL of ethanol. The wet cake was dried to obtain dry EMM-71.

FIG. 7 shows the powder X-ray diffraction patterns of the EMM-71 materials of examples 2A to 2G. It can be seen from said XRD patterns that good quality EMM-71 materials were obtained for at least examples 2A to 2E. Examples 2F and 2G, conducted with respectively 80 and 100 mol % DEHT, showed a lower diffraction intensity and the presence of some impurities.

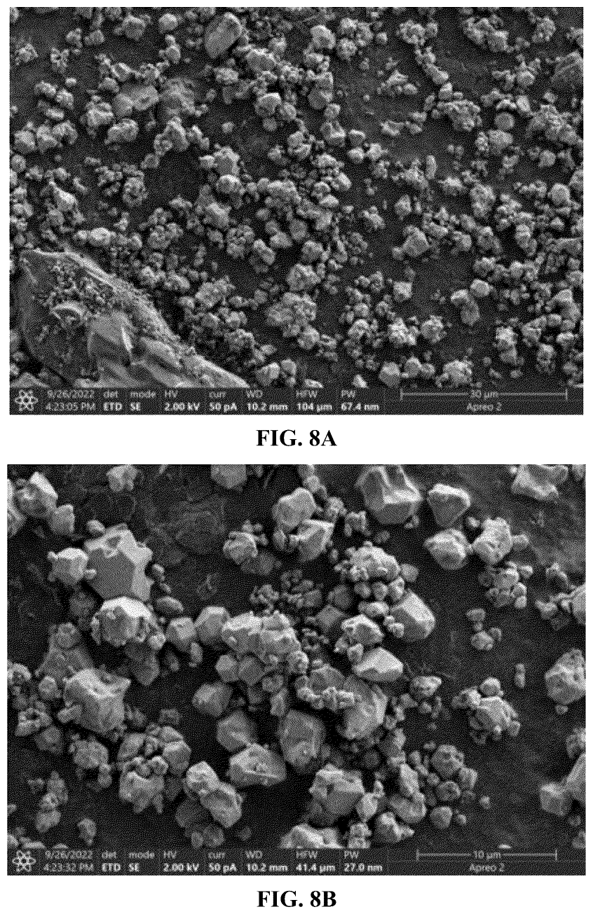

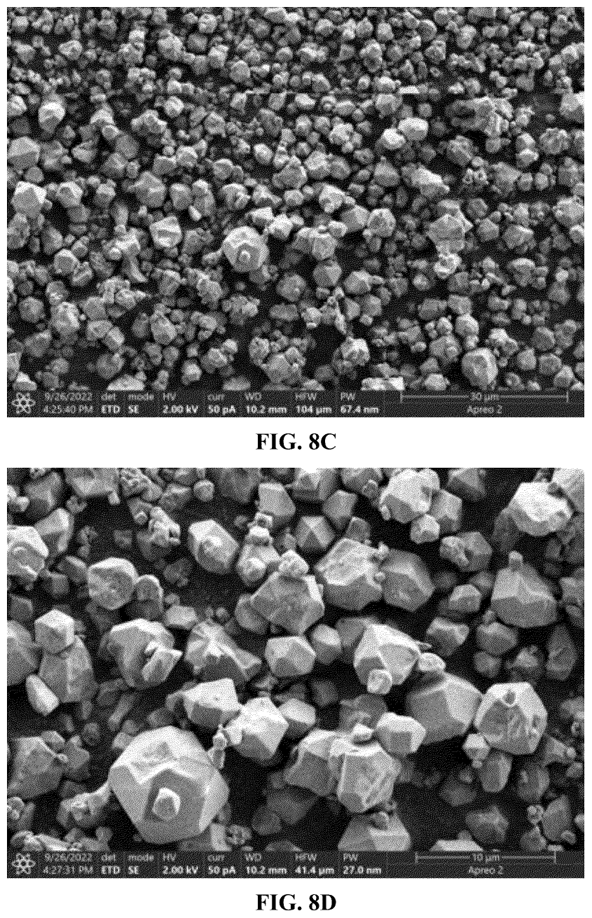

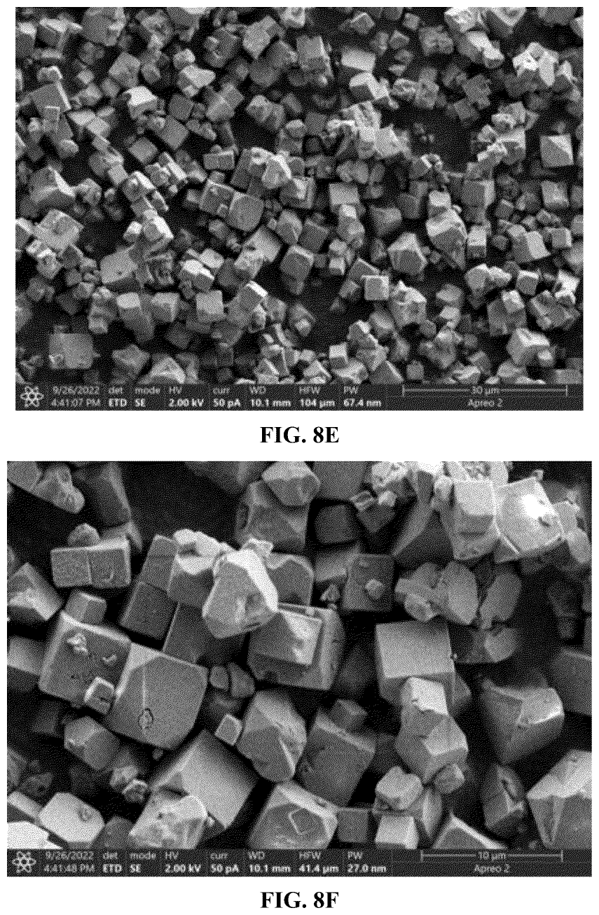

FIG. 8A to 8F are SEM micrographs of the EMM-71 materials of example 2B, 2C and 2D at respectively 30 and 10 μm scale. More particularly, FIG. 8A-8B correspond to example 2B (10 mol % DEHT), FIG. 8C-8D correspond to example 2C (20 mol % DEHT), and FIG. 8E-8F correspond to example 2D (40 mol % DEHT).

FIG. 9 is a plot of the FWHM of the (111) (●) and (110) (▪) peaks of the EMM-71 materials of examples 2A to 2F.

The line in FIG. 9 represents the pore volume (cc/g) of the EMM-71 materials of examples 2A to 2D, as measured by nitrogen adsorption at 77K at 0.8 P/P₀.

It can be seen from examples 2A to 2G that the use of DEHT as a second pre-ligand in combination with DMT as a first pre-ligand in the reaction mixture results in the preparation of large, more uniform crystals, but also produce higher degrees of REO phase as evidenced by the XRD patterns and by increased pore volume.

### Examples 3A-3G: Synthesis of EMM-71 with a Mixture of Dimethylterephthalate (DMT) and Benzene Dicarboxylic Acid (BDC)

For a given reaction, 2.64 g of zirconium oxychloride octahydrate and 0.84 g of hafnium oxychloride hydrate, resulting in a 80/20 mixture (expressed by moles) of ZrOCl₂ and HfOCl₂, were charged in a reactor with 6.9 mmol of total BDC/DMT compounds, resulting in the following compositions: 5 mol % BDC (example 3A), 10 mol % BDC (example 3B), 15 mol % BDC (example 3C), 20 mol % BDC (example 3D), 25 mol % BDC (example 3E), 30 mol % 10 mol % BDC (example 3F), and 35 mol % BDC (example 3G). For example, for a mixture BDC/DMT with 5 mol % BDC (Example 3A), 1.3 g of DMT and 0.06 g of BDC was used. For a mixture BDC/DMT with 20 mol % BDC (Example 3D), 1.1 g of DMT and 0.23 g of BDC were used. 0.5 mL of hydrochloric acid (˜37 wt. %) was added followed by 1.5 mL of glacial acetic acid. The mixture was mixed and sealed. The reactor was heated to 150° C. over the course of 6 hours and then soaked for at least 10 hours. The reaction mixtures were then cooled, diluted and neutralized then filtered and washed with aqueous formic acid and ethanol.

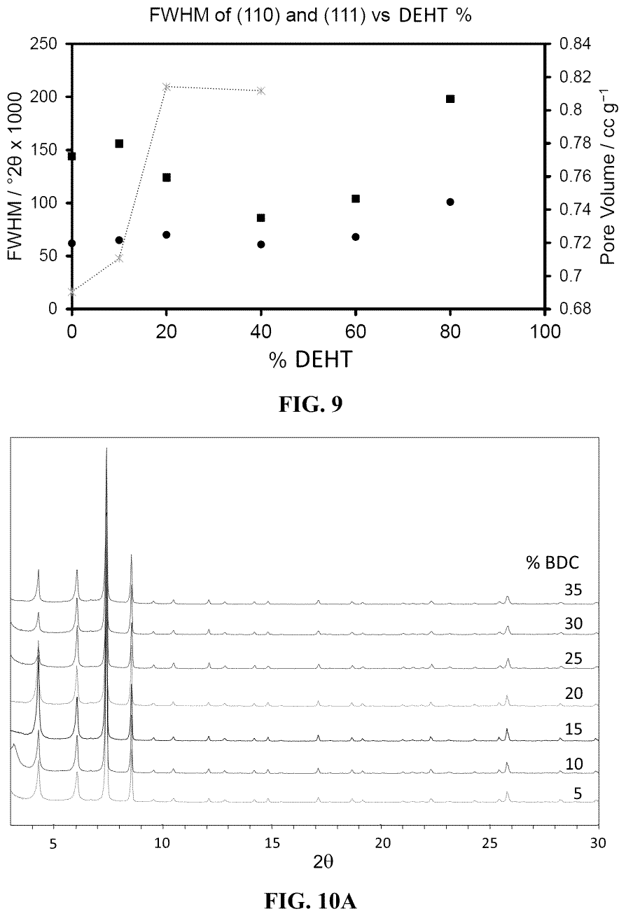

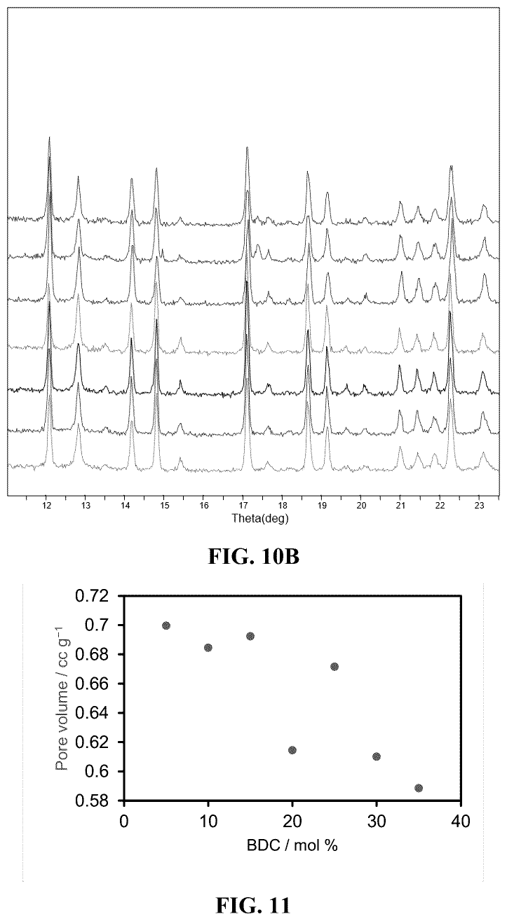

FIG. 10A and FIG. 10B show the powder X-ray diffraction patterns of the EMM-71 materials of examples 3A to 3G. It can be seen from said XRD patterns that good quality EMM-71 materials were obtained for all of examples 3A to 3G.

FIG. 11 is a plot of the pore volume (cc/g) of the EMM-71 materials of examples 3A to 3G. As shown in FIG. 11, when the reaction mixture has an amount of greater than 15 mole percent of BDC, pore volumes of the metal-organic frameworks are lower. This is concomitant with an excess BDC showing up in the x-ray diffraction pattern (FIG. 10B).

### Examples 4A-4I: Synthesis of EMM-71 with Zr(OH)₄ as Alternative Metal Source

For a given reaction, DMT and Zr(OH)₄ were charged in a reactor (“reactants”). Hydrochloric acid (˜37 wt. %) was added followed by glacial acetic acid (“solvents”). Table 1 below sets out the amounts of reactants and solvent in the reaction mixture, including the wt. % reactants (amount of reactants by weight of the total mixture comprising the reactants and solvents). The reaction mixture was mixed and sealed. The reactor was heated to 80° C. for 5 hours then heated to 150° C. and then soaked for at least 10 hours. The reaction mixtures were then cooled, diluted and neutralized, then filtered and washed with aqueous formic acid and ethanol.

TABLE 1

| | | | | Acetic | | Pore |
|---|---|---|---|---|---|---|
| | DMT | Zr(OH)₄ | HCl | Acid | wt. % | Volume |
| Examples | (g) | (g) | (mL) | (mL) | reactants | (cc/g) |
| 4A | 2.7 | 3.3 | 6.0 | 3.0 | 36.7 | 0.830 |
| 4B | 2.7 | 3.3 | 5.5 | 3.0 | 38.1 | 0.789 |
| 4C | 2.7 | 3.3 | 5.0 | 3.0 | 39.6 | 0.792 |
| 4D | 2.7 | 3.3 | 4.0 | 3.0 | 43.0 | 0.755 |
| 4E | 1.35 | 1.63 | 2.5 | 1.5 | 39.4 | — |
| 4F | 1.35 | 1.63 | 2.0 | 1.5 | 42.8 | — |
| 4G | 1.3 | 1.63 | 1.5 | 1.5 | 46.5 | 0.584 |
| 4H | 1.3 | 1.63 | 1.0 | 1.5 | 51.3 | 0.468 |
| 4I | 1.3 | 1.63 | 0.5 | 1.5 | 58.4 | — |

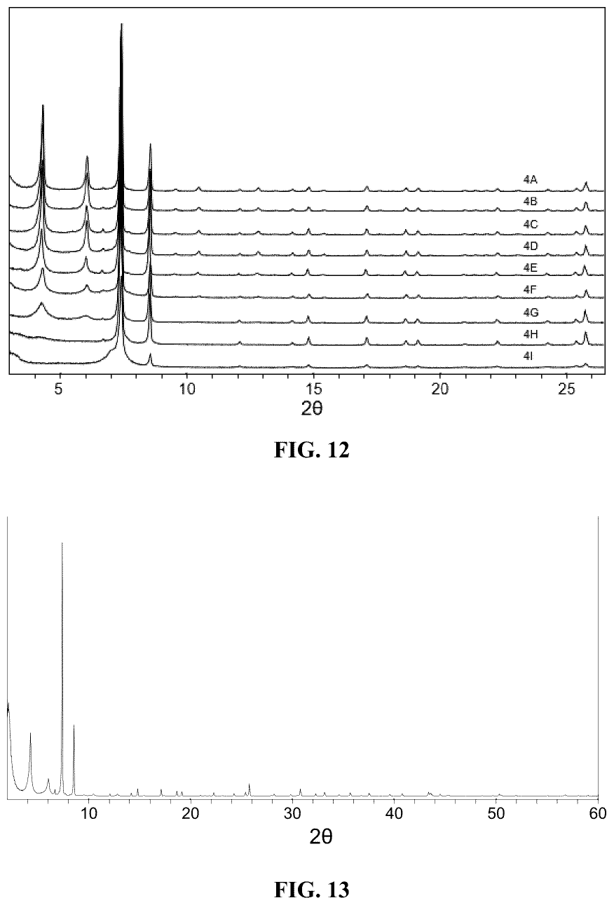

The powder X-ray diffraction patterns of the EMM-71 materials of examples 4A to 4I are shown in FIG. 12 (upper curve corresponding to example 4A and bottom curve corresponding to example 4I). As can be seen from FIG. 12, good quality EMM-71 materials were obtained for examples 4A to 4F while the materials of examples 4G, 4H and 4I resulted in EMM-71 materials of poorer quality (lower diffraction intensity).

These examples illustrate that using Zr(OH)₄ as an alternative starting material allows for the preparation of good quality EMM-71 materials, as long as a sufficient amount of solvent is provided in the reaction mixture.

These examples also illustrate that when the amount of mineral acid (e.g., HCl) is increased relative to the ligand and/or the monocarboxylic acid (e.g., acetic acid), the pore volume of the EMM-71 materials is increased, which is especially advantageous and also indicates an increase in REO domain %.

Last but not least, it was surprisingly found that the use of Zr(OH)₄ as an alternative starting material resulted in EMM-71 having a smaller particle size and a narrower particle size distribution, as illustrated below.

Table 2 provides a comparison of the particle size (mean, median, mode, D10, D90 as measured by laser sizing) and particle size distribution width (span) of the EMM-71 materials of examples 3A and 3B (prepared using Zr(OH)₄ as metal source), as compared to the EMM-71 material of comparative example 2 (prepared using ZrOCl₂ as metal source). The mean particle size is a calculated value similar to the concept of average, reported on a volume basis. The median particle size (or D50) is defined as the value that splits the distribution with half above and half below this particle size (by volume). The mode particle size represents the particle size most commonly found in the distribution (by volume), i.e., it is the most statistically prevalent particle size (or the peak of the frequency distribution, corresponding to the highest peak seen in the particle size distribution). Similarly to D50 (median), D10 and D90 correspond to the values where respectively 10% and 90% of the population lie below (by volume). The span (or width) of the particle size distribution is given by formula (D90-D10)/D50 where D50 is the median particle size.

TABLE 2

| Particle size | EMM-71 of | EMM-71 of | EMM-71 of |
|---|---|---|---|
| (μm) | Comparative Ex. 2 | Example 3B | Example 3A |
| MEAN | 3.54 | 2.97 | 2.20 |
| MEDIAN (D50) | 2.65 | 2.08 | 2.18 |
| MODE | 2.43 | 2.12 | 2.14 |
| D10 | 1.82 | 1.17 | 1.51 |
| D90 | 4.73 | 3.02 | 3.07 |
| SPAN | 1.1 | 0.9 | 0.7 |

Reduction in particle size is especially advantageous as it results in decreased molecular diffusion and enhanced adsorption processes.

### Example 5: Synthesis of EMM-71 with Zr(OH)₄ in a Mixture of Hydrochloric Acid and Propionic Acid

Good quality EMM-71 material was also obtained from the following example. 12.8 g of dimethyl terephthalate (DMT) and 15.7 g of zirconium hydroxide (Zr(OH)₄) were weighed into a reactor. 31.3 g of hydrochloric acid (˜37 wt. %) and 20.8 g of propionic acid (100 wt. %) were added to the reactor. The reactor was sealed and heated to 120° C. using a slow ramp that was held at between 30 and 80° C. between 2 to 6 hours during an initial heating step. The reactor was then held at 120° C. for 6-20 hours. The reactor was then allowed to cool to room temperature and the contents of the reaction diluted with water to 200 mL and neutralized with sodium formate to a pH of between 3 and 4. The neutralized slurry was heated to 85° C. for 2 hours then filtered and washed with water, a 0.1 wt. % aqueous formic acid solution, and ethanol.

FIG. 13 shows the powder X-ray diffraction patterns of the EMM-71 material of example 5.

### Additional Embodiments

Additionally or alternately, the invention relates to:

Embodiment 1. A method of making a metal-organic framework comprising:
(a) combining a first pre-ligand and at least one of a second pre-ligand or a first ligand, with a metal source comprising a metal component to provide a plurality of reactants;
(b) adding a solvent to the plurality of reactants to form a reaction mixture, wherein at least 50 wt. % of the reaction mixture is the plurality of reactants;
(c) heating the reaction mixture wherein the first pre-ligand is converted to a second ligand in the reaction mixture, the second pre-ligand if present is converted to a third ligand in the reaction mixture, and the second ligand and the at least one of the first ligand or third ligand react with the metal component; and
(d) cooling the reaction mixture to produce an insoluble portion and a soluble portion, wherein the insoluble portion comprises a plurality of the metal-organic frameworks, each metal-organic framework comprising at least one ligand and the metal component, wherein the first pre-ligand is selected from the group consisting of
dimethylfumarate, dimethyl terephthalate, terephthalonitrile (1,4-dicyanobenzene), terephthalamide (1,4-benzenedicarboxamide), N¹,N⁴-dimethylterepthalamide, dimethyl 2-aminoterephthalate, dimethyl 2-nitroterephthalate, dimethyl 2-chloroterephthalate, dimethyl 2-bromoterephthalate, trimethyl 1,2,4-benzene tricarboxylate, trimethyl 1,3,5-benzene tricarboxylate, tetramethyl 1,2,4,5-benzene tetracarboxylate, polyethylene terephthalate, and mixtures thereof;
wherein the second pre-ligand is selected from the group consisting of C2-C10 linear or branched alkyl esters of fumarate, terephthalate, 2-aminoterephthalate, 2-nitroterephthalate, 2-chloroterephthalate, 2-bromoterephthalate, 1,2,4-benzene tricarboxylate, 1,3,5-benzene tricarboxylate, 1,2,4,5-benzene tetracarboxylate, and mixtures thereof, and
wherein the first ligand is selected from the group consisting of fumaric acid, terephthalic acid, 2-aminoterephthalic acid, 2-nitroterephthalic acid, 2-chloroterephthalic acid, 2-bromoterephthalic acid, 1,2,4-benzene tricarboxylic acid, 1,3,5-benzene tricarboxylic acid, 1,2,4,5-benzene tetracarboxylic acid, and mixtures thereof.

Embodiment 2. The method of embodiment 1, wherein the mole ratio of the second pre-ligand and/or first ligand to the first pre-ligand is from greater than 0 to 0.6, preferably from 0.05 to 0.5, more preferably from 0.1 to 0.5, most preferably from 0.2 to 0.4.

Embodiment 3. The method of embodiments 1 or 2, wherein a first pre-ligand is combined with a second pre-ligand, and the second and third ligands are the same, in particular the second and third ligands are fumaric acid or terephthalic acid, more particularly terephthalic acid.

Embodiment 4. The method of embodiment 1 or 2, wherein a first pre-ligand is combined with a first ligand, and the first and second ligands are the same, in particular the first and second ligands are fumaric acid or terephthalic acid, more particularly terephthalic acid.

Embodiment 5. The method of any one of the preceding embodiments, wherein the first pre-ligand is at least one of dimethylfumarate, polyethylene terephthalate, or a methyl ester terephthalate or a derivative thereof, such as dimethyl terephthalate, dimethyl 2-aminoterephthalate, dimethyl 2-nitroterephthalate, dimethyl 2-chloroterephthalate, or dimethyl 2-bromoterephthalate; more preferably at least one of dimethylfumarate and dimethylterephthalate, in particular dimethylterephthalate.

Embodiment 6. The method of any one of the preceding embodiments, wherein the second pre-ligand is selected from the group consisting of C2-C8 linear or branched alkyl esters, in particular the alkyl groups are selected from ethyl, octyl, and 2-ethylhexyl.

Embodiment 5. The method of any one of the preceding embodiments, wherein the second pre-ligand is a compound of the formula

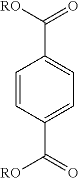

wherein R is independently selected from the group of C2 to C10 linear or branched alkyl groups, preferably from ethyl, octyl, and 2-ethylhexyl, more preferably both R are the same, most preferably the second pre-ligand is selected from diethylterephthalate, dioctylterephthalate, and diethylhexylterephthalate.

Embodiment 7. The method of any one of the preceding embodiments, wherein at least one of the second pre-ligands is a liquid at 20° C.

Embodiment 8. The method of any one of the preceding embodiments, wherein the first ligand is at least one of fumaric acid and terephthalic acid or a derivative thereof, more particularly terephthalic acid.

Embodiment 9. The method of any one of the preceding embodiments, wherein the solvent includes at least one of a monocarboxylic acid and/or a mineral acid, and optionally water, preferably a monocarboxylic acid and a mineral acid.

Embodiment 10. The method of any one of the preceding embodiments, wherein the solvent is added to the reaction mixture in an amount from 0.1 and 1.0 weight equivalents relative to the plurality of reactants, preferably from 0.1 to less than 1.0, more preferably up to 0.9, 0.8, 0.7, 0.6, 0.5, 0.4, 0.3, or 0.2.

Embodiment 11. The method of any one of the preceding embodiments, wherein the solvent comprises a mineral acid and the amount (as mol ratio) of mineral acid to ligand(s) in the reaction mixture is at most 5:1, preferably from 1:10 to 5:1, more preferably from 1:2 to 3:1, most preferably from 1:1 to 2:1.

Embodiment 12. The method of any one of the preceding embodiments, wherein the reaction mixture does not comprise dimethylformamide.

Embodiment 13. A method of making a metal-organic framework comprising:
combining a pre-ligand with a metal source comprising a metal component to provide a plurality of reactants, wherein the metal source is selected from the group consisting of metal hydroxides, metal acetates, metal hydroxyacetates, metal carbonates, metal hydroxycarbonates, and mixtures thereof;
adding a solvent to the plurality of reactants to form a reaction mixture, wherein between 15 wt. % and 50 wt. % of the reaction mixture is the plurality of reactants;
heating the reaction mixture wherein the pre-ligand is converted to a ligand in the reaction mixture and the ligand reacts with the metal component; and
cooling the reaction mixture to produce an insoluble portion and a soluble portion, wherein the insoluble portion comprises a plurality of the metal-organic frameworks, each metal-organic framework comprising the ligand and the metal component;
wherein the reaction mixture does not comprise dimethylformamide.

Embodiment 14. The method of embodiment 13, wherein the pre-ligand is selected from the group consisting of dimethylfumarate, dimethyl terephthalate, terephthalonitrile (1,4-dicyanobenzene), terephthalamide (1,4-benzenedicarboxamide), N¹,N⁴-dimethylterepthalamide, dimethyl 2-aminoterephthalate, dimethyl 2-nitroterephthalate, dimethyl 2-chloroterephthalate, dimethyl 2-bromoterephthalate, trimethyl 1,2,4-benzene tricarboxylate, trimethyl 1,3,5-benzene tricarboxylate, tetramethyl 1,2,4,5-benzene tetracarboxylate, polyethylene terephthalate, and mixtures thereof; preferably at least one of dimethylfumarate, polyethylene terephthalate, or a methyl ester terephthalate or a derivative thereof, such as dimethyl terephthalate, dimethyl 2-aminoterephthalate, dimethyl 2-nitroterephthalate, dimethyl 2-chloroterephthalate, or dimethyl 2-bromoterephthalate; more preferably at least one of dimethylfumarate and dimethylterephthalate, in particular dimethylterephthalate.

Embodiment 15. The method of any one of embodiments 13-14, wherein the metal component is zirconium and the metal source is selected from the group consisting of zirconium hydroxide (Zr(OH)₄), zirconium acetate (Zr(OAc)₄), zirconium acetate hydroxide (Zr(OAc)ₓ(OH)_{y} where x+y is about 4), zirconium carbonate Zr(CO₃)₂, zirconium hydroxycarbonate (Zr(OH)₂CO₃ZrO₂), and mixtures thereof, in particular zirconium hydroxide.

Embodiment 16. The method of any one of embodiments 13-15, wherein the solvent includes at least one of a monocarboxylic acid and/or a mineral acid, and optionally water, preferably a monocarboxylic acid and a mineral acid.

Embodiment 17. The method of any one of embodiments 13-16, wherein between 15 wt. % and 50 wt. % of the reaction mixture is the plurality of reactants, preferably from 25 wt. % to less than 50 wt. %, in particular from 30 wt. % to less than 50 wt. %, more particularly from 30 wt. % or from 35 wt. % to 45 wt. %.

Embodiment 18. The method of any one of embodiments 13-17, wherein the solvent is added to the reaction mixture in an amount from 1.0 to 4.0 weight equivalents relative to the plurality of reactants, preferably from greater than 1.0 to 3.0, more preferably from 1.2 to 2.5.

Embodiment 19. The method of any one of embodiments 13-18, wherein the solvent comprises a mineral acid and the amount (as mol ratio) of mineral acid to ligand in the reaction mixture is from 1:1 to 20:1, preferably from 1:1 to 10:1, more preferably from 2:1 to 8:1, most preferably from greater than 2:1 to 6:1.

Embodiment 20. The method of any one of embodiments 13-19, wherein the solvent comprises both a monocarboxylic acid and a mineral acid, and the amount (as mol ratio) of mineral acid to monocarboxylic acid in the reaction mixture is at most 8:1, preferably from 1:5 to 8:1, more preferably from 1:4 to 6:1, most preferably from 1:3 to 5:1, in particular from 1:2 to 4:1, more particularly from 3:4 to 3:1 or to 2:1.

Embodiment 21. The method of any one of the preceding embodiments, wherein the metal component is a tetravalent metal selected from the group consisting of zirconium, titanium, cerium, hafnium, and combinations thereof, preferably Zr or Zr/Hf.

Embodiment 22. The method of any one of the preceding embodiments, wherein the reaction mixture is heated to a temperature of from about 100° C. to 220° C., preferably from 100° C. to 160° C., more preferably from 140° C. to 160° C.

Embodiment 23. The method of any one of the preceding embodiments, wherein the solvent comprises a monocarboxylic acid, preferably wherein the monocarboxylic acid is selected from the group consisting of acetic acid, formic acid, propionic acid, and mixtures thereof.

Embodiment 24. The method of any one of the preceding embodiments, wherein the solvent comprises a mineral acid, preferably wherein the mineral acid is selected from the group consisting of hydrochloric acid, hydrobromic acid, and mixtures thereof.

Embodiment 25. The method of any one of the preceding embodiments, wherein the solvent comprises a monocarboxylic acid and the amount (as mol ratio) of monocarboxylic acid to ligand(s) in the reaction mixture is from 1:1 to 20:1, in particular from 1:1 to less than 20:1, preferably from 1:1 to 10:1, more preferably from 2:1 to 8:1, most preferably from 3:1 to 5:1.

Embodiment 26. The method of any one of the preceding embodiments, further comprising: separating the insoluble portion from the soluble portion; and/or drying the insoluble portion to produce a plurality of the metal-organic frameworks.

Embodiment 27. The method of any one of the preceding embodiments, wherein the metal-organic framework is selected from the group consisting of UiO-66, EMM-71, zirconium fumarate, MOF-808, NU-1000, or a functionalized derivative thereof, in particular EMM-71.

Embodiment 28. The method of any one of the preceding embodiments, wherein the metal-organic framework is a Zr-terephthalate metal-organic framework or a Zr-Hf-terephthalate metal-organic framework.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

1. A method of making a metal-organic framework comprising:
combining a first pre-ligand and at least one of a second pre-ligand or a first ligand, with a metal source comprising a metal component to provide a plurality of reactants;
adding a solvent to the plurality of reactants to form a reaction mixture, wherein at least 50 wt. % of the reaction mixture is the plurality of reactants;
heating the reaction mixture wherein the first pre-ligand is converted to a second ligand in the reaction mixture, the second pre-ligand if present is converted to a third ligand in the reaction mixture, and the second ligand and the at least one of the first ligand or third ligand react with the metal component; and
cooling the reaction mixture to produce an insoluble portion and a soluble portion, wherein the insoluble portion comprises a plurality of the metal-organic frameworks, each metal-organic framework comprising at least one ligand and the metal component,
wherein the first pre-ligand is selected from the group consisting of dimethylfumarate, dimethyl terephthalate, terephthalonitrile (1,4-dicyanobenzene), terephthalamide (1,4-benzenedicarboxamide), N¹,N⁴-dimethylterepthalamide, dimethyl 2-aminoterephthalate, dimethyl 2-nitroterephthalate, dimethyl 2-chloroterephthalate, dimethyl 2-bromoterephthalate, trimethyl 1,2,4-benzene tricarboxylate, trimethyl 1,3,5-benzene tricarboxylate, tetramethyl 1,2,4,5-benzene tetracarboxylate, polyethylene terephthalate, and mixtures thereof,
wherein the second pre-ligand is selected from the group consisting of C2-C10 linear or branched alkyl esters of fumarate, terephthalate, 2-aminoterephthalate, 2-nitroterephthalate, 2-chloroterephthalate, 2-bromoterephthalate, 1,2,4-benzene tricarboxylate, 1,3,5-benzene tricarboxylate, 1,2,4,5-benzene tetracarboxylate, and mixtures thereof, and
wherein the first ligand is selected from the group consisting of fumaric acid, terephthalic acid, 2-aminoterephthalic acid, 2-nitroterephthalic acid, 2-chloroterephthalic acid, 2-bromoterephthalic acid, 1,2,4-benzene tricarboxylic acid, 1,3,5-benzene tricarboxylic acid, 1,2,4,5-benzene tetracarboxylic acid, and mixtures thereof.

2. The method of claim 1, wherein the mole ratio of the second pre-ligand and/or first ligand to the first pre-ligand is from greater than 0 to 0.6.

3. The method of claim 1, wherein a first pre-ligand is combined with a second pre-ligand, and the second and third ligands are the same, in particular the second and third ligands are fumaric acid or terephthalic acid, more particularly terephthalic acid.

4. The method of claim 1, wherein a first pre-ligand is combined with a first ligand, and the first and second ligands are the same, in particular the first and second ligands are fumaric acid or terephthalic acid, more particularly terephthalic acid.

5. The method claim 1, wherein the second pre-ligand is a compound of the formula 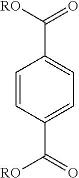
wherein R is independently selected from the group of C2 to C10 linear or branched alkyl, in particular from ethyl, octyl, and 2-ethylhexyl.

6. The method of claim 1, wherein at least one of the second pre-ligands is a liquid at 20° C.

7. The method of claim 1, wherein the solvent is added to the reaction mixture in an amount between 0.1 and 1.0 weight equivalents relative to the plurality of reactants.

8. The method of claim 1, wherein the reaction mixture does not comprise dimethylformamide.

9. A method of making a metal-organic framework comprising:
combining a pre-ligand with a metal source comprising a metal component to provide a plurality of reactants, wherein the metal source is selected from the group consisting of metal hydroxides, metal acetates, metal hydroxyacetates, metal carbonates, metal hydroxycarbonates, and mixtures thereof;
adding a solvent to the plurality of reactants to form a reaction mixture, wherein between 15 wt. % and 50 wt. % of the reaction mixture is the plurality of reactants;
heating the reaction mixture wherein the pre-ligand is converted to a ligand in the reaction mixture and the ligand reacts with the metal component; and
cooling the reaction mixture to produce an insoluble portion and a soluble portion, wherein the insoluble portion comprises a plurality of the metal-organic frameworks, each metal-organic framework comprising the ligand and the metal component and the reaction mixture does not comprise dimethylformamide.

10. The method of claim 9, wherein the pre-ligand is selected from the group consisting of dimethylfumarate, dimethyl terephthalate, terephthalonitrile (1,4-dicyanobenzene), terephthalamide (1,4-benzenedicarboxamide), N¹,N⁴-dimethylterepthalamide, dimethyl 2-aminoterephthalate, dimethyl 2-nitroterephthalate, dimethyl 2-chloroterephthalate, dimethyl 2-bromoterephthalate, trimethyl 1,2,4-benzene tricarboxylate, trimethyl 1,3,5-benzene tricarboxylate, tetramethyl 1,2,4,5-benzene tetracarboxylate, polyethylene terephthalate, and mixtures thereof.

11. The method of claim 9, wherein the solvent is added to the reaction mixture in an amount between 1.0 and 4.0 weight equivalents relative to the plurality of reactants.

12. The method of claim 9, wherein the metal component is a tetravalent metal selected from the group consisting of zirconium, titanium, cerium, hafnium, and combinations thereof, preferably wherein the metal-organic framework is a zirconium metal-organic framework or a zirconium-based metal-organic framework further comprising hafnium.

13. The method of claim 9, wherein the reaction mixture is heated to a temperature to about 100° C. and 220° C.

14. The method of claim 9, wherein the solvent comprises at least one of a monocarboxylic acid and/or a mineral acid, and optionally water.

15. The method of claim 14, wherein the monocarboxylic acid is selected from the group consisting of acetic acid, formic acid, propionic acid, and mixtures thereof.

16. The method of claim 14, wherein the mineral acid is selected from the group consisting of hydrochloric acid, hydrobromic acid, and mixtures thereof.

17. The method of claim 14, wherein the solvent comprises a monocarboxylic acid and the amount (as mol ratio) of monocarboxylic acid to ligand(s) in the reaction mixture is from 1:1 to 20:1.

18. The method of any one of claim 9, wherein the solvent comprises a monocarboxylic acid and a mineral acid and the amount (as mol ratio) of mineral acid to monocarboxylic acid in the reaction mixture is from 1:5 to 8:1.

19. The method of claim 9, further comprising:
separating the insoluble portion from the soluble portion; and/or
drying the insoluble portion to produce a plurality of the metal-organic frameworks.

20. The method of claim 9, wherein the metal-organic framework is selected from the group consisting of UiO-66, EMM-71, zirconium fumarate, MOF-808, NU-1000, or a functionalized derivative thereof.

21. The method of claim 9, wherein the metal-organic framework is a Zr-terephthalate metal-organic framework or a Zr-Hf-terephthalate metal-organic framework.
